(19) United States
(12) Patent Application Publication
(10) Pub. No.: US 2025/0245458 A1
(43) Pub. Date: Jul. 31, 2025

(54) CODE READER AND IMAGE PROCESSING DEVICE

(71) Applicant: Keyence Corporation, Osaka (JP)

(72) Inventors: Hiroomi OHORI, Osaka (JP); Taichi TAJIKA, Osaka (JP)

(73) Assignee: Keyence Corporation, Osaka (JP)

(21) Appl. No.: 18/988,975

(22) Filed: Dec. 20, 2024

(30) Foreign Application Priority Data
Jan. 26, 2024 (JP) 2024-010565

(51) Int. Cl. G06K 7/14

(52) U.S. Cl. CPC G06K 7/1417

(57) ABSTRACT

A stationary code reader includes a housing that is long along a first direction and has a light receiving window that transmits light laterally intersecting the first direction, an illumination section that is stored in the housing and forms an irradiation surface arranged side by side with a light receiving window along the first direction, an imaging unit having an image sensor installed toward the first direction, a mirror that turns back an optical path corresponding to a visual field of the imaging unit toward the light receiving window in the housing, and an attachment portion that is provided on a side of the housing and configured to attach the housing to an external frame.

### CROSS-REFERENCE TO RELATED APPLICATIONS

The present application claims foreign priority based on Japanese Patent Application No. 2024-010565, filed Jan. 26, 2024, the contents of which are incorporated herein by reference.

### BACKGROUND OF THE INVENTION

### 1. Technical Field

The disclosure relates to a code reader that reads a code attached to a workpiece conveyed by a conveyance device, and an image processing device that processes an image obtained by capturing an image of the workpiece.

### 2. Description of the Related Art

This type of code reader is used, for example, in a case where a code attached to a workpiece conveyed by a conveyance device is read at a distribution site or the like. The code reader disclosed in JP 2021-149656 A includes an illumination section that illuminates a workpiece and an imaging unit that receives reflected light from the workpiece and generates a code image. The illumination section includes a plurality of illumination blocks, and a light receiving window that transmits reflected light from the workpiece is provided in a portion surrounded by the illumination block on the front side of the code reader.

The light transmitted through the light receiving window is received by the imaging unit disposed on the back side of the illumination block.

The code reader may be used in a state of being attached to an external frame. In a case where the code reader is attached to the frame and used, when the code reader protrudes from the frame toward the conveyance device side, a problem of interference with a workpiece conveyed by the conveyance device is likely to occur. Therefore, there is a demand for minimizing the protrusion amount of the code reader from the frame toward the conveyance device side.

In this regard, in the code reader of JP 2021-149656 A, the plurality of illumination blocks is arranged so as to surround the light receiving window, and the imaging unit is arranged on the back side of the illumination blocks, so that the dimension in the depth direction becomes long. For this reason, if it is assumed that the code reader of JP 2021-149656 A is attached to the frame and operated, it is conceivable that the code reader greatly protrudes toward the conveyance device side. This may cause a decrease in the degree of freedom in installation of the code reader.

### SUMMARY OF THE INVENTION

The disclosure has been made in view of such a point, and an object of the disclosure is to reduce a protrusion amount of a code reader from a frame to a conveyance device side to improve a degree of freedom in installation in a case where the code reader is attached to an external frame and used.

In order to achieve the above object, in the present aspect, a stationary code reader that is configured to be usable in a state of being attached to an external frame and that reads a code attached to a workpiece conveyed by a conveyance device can be assumed. A code reader includes: a housing that is long along a first direction and has a light receiving window that transmits light laterally intersecting the first direction; an illumination section that is stored in the housing and forms an irradiation surface arranged side by side with the light receiving window along the first direction, the irradiation surface for irradiating a workpiece with illumination light; an imaging unit including an image sensor and a lens, the image sensor having a two-dimensional light receiving surface and being installed in the housing toward the first direction, the lens projecting an image corresponding to a code attached to a workpiece on a light receiving surface of the image sensor in the housing; a mirror that turns back an optical path corresponding to a visual field of the imaging unit in a direction of the light receiving window in the housing; a decoder that executes decoding processing of the code attached to the workpiece based on the image generated by the imaging unit; and an attachment portion that is provided on a side of the housing different from a side of the light receiving window and configured to attach the housing to the external frame.

According to this configuration, since the housing is long along the first direction, for example, the housing arranged such that the longitudinal direction of the external frame coincides with the first direction of the housing can be attached to the external frame by the attachment portion. In this housing, since the irradiation surface of the illumination light formed by the illumination section is aligned with the light receiving window along the first direction, when the optical axis direction of the illumination light with which the code is irradiated is taken as a reference, the dimension of the housing in that direction is shortened. Therefore, the protrusion amount of the code reader from the external frame to the conveyance device side is reduced.

A communication interface that is provided at an end in the first direction of the housing and configured to transmit information regarding a result of decoding processing by the decoder can be provided. In this case, since the direction in which the communication line is connected to the communication interface is the direction along the first direction, the protrusion amount of the code reader including the communication line toward the conveyance device side is reduced.

As described above, in a case where the code reader is attached to the external frame and used, the protrusion amount of the code reader from the frame to the conveyance device side is reduced, so that the degree of freedom in installation can be improved.

### BRIEF DESCRIPTION OF THE DRAWINGS

FIG. 1 is a perspective view for explaining an operation of a code reader according to an embodiment of the invention;

FIG. 2 is a front view illustrating an installation state of a code reader;

FIG. 3 is a block diagram of the code reader;

FIG. 4 is a schematic diagram illustrating a relationship between a Scheimpflug optical system and a focal plane;

FIG. 5 is a perspective view of the code reader;

FIG. 6 is a front view of the code reader;

FIG. 7 is a bottom view of the code reader;

FIG. 8 is a perspective view of the code reader illustrating a state in which a box-shaped case is removed;

FIG. 9 is an enlarged cross-sectional view of a mating portion between the box-shaped case and the lid-shaped case;

FIG. 10 is an enlarged cross-sectional view of the mating portion between the box-shaped case and the window frame;

FIG. 11 is a cross-sectional view of a first illumination section;

FIG. 12 is a longitudinal cross-sectional view of the lid-shaped case in the left-right direction;

FIG. 13 is a longitudinal cross-sectional view of the lid-shaped case in a depth direction;

FIG. 14 is a perspective view of a lens holder;

FIG. 15 is a view corresponding to FIG. 14 in a state where the sensor substrate is removed;

FIG. 16 is a view corresponding to FIG. 14 in a state where a sensor holder is removed;

FIG. 17 is a view for explaining a state of capturing an image of a bottom surface of a workpiece being conveyed;

FIG. 18 is a flowchart illustrating an example of a series of processing from capturing an image to reading result output;

FIG. 19 is a side view illustrating an example of attachment of the code reader to a frame;

FIG. 20 is a view corresponding to FIG. 19 in a case where angles are different;

FIG. 21 is a front view of a state of being attached to the frame;

FIG. 22 is a bottom view of a housing having a bracket;

FIG. 23 is a side view illustrating an installation example in which an optical axis is orthogonal to a reference surface;

FIG. 24 is a side view illustrating an installation example using a mirror;

FIG. 25 is a side view illustrating a comparison of an installation example in a case where the bracket is attached to a different side surface;

FIG. 26 is a view illustrating a schematic structure of a code reader according to a first example of another embodiment;

FIG. 27 is a view illustrating a visual field and a depth of the code reader according to the first example;

FIG. 28 is a view illustrating a visual field and a depth of a code reader according to a second example;

FIG. 29 is a view illustrating a schematic structure of a code reader according to a third example;

FIG. 30 is a view illustrating a schematic structure of a code reader according to a fourth example; and

FIG. 31 is a view illustrating a visual field and a depth of a code reader according to a fifth example.

### DETAILED DESCRIPTION

Hereinafter, embodiments of the invention will be described in detail with reference to the drawings. It is to be noted that the following description of preferred embodiments is merely exemplary in nature and is not intended to limit the invention, its application, or its use.

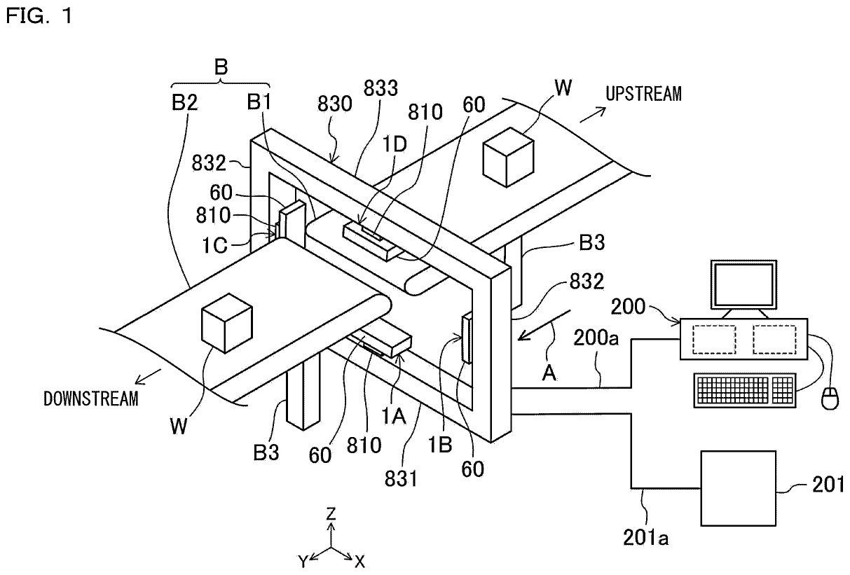

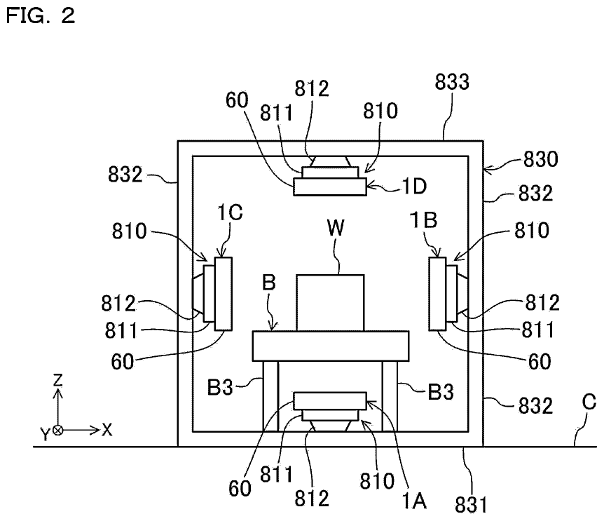

FIG. 1 is a view schematically illustrating operation of code readers 1A, 1B, 1C, and 1D according to an embodiment of the invention. In addition, FIG. 2 is a front view illustrating installation states of the code readers 1A, 1B, 1C, and 1D. In this example, a case where a plurality of code readers 1A, 1B, 1C, and 1D are used at a distribution site that handles a plurality of workpieces W is illustrated. In the distribution site, a conveyance device B for sequentially conveying the plurality of workpieces W in a predetermined conveyance direction is installed. The conveyance direction of the workpiece W is indicated by an arrow A of FIG. 1. Therefore, the right side in FIG. 1 is the upstream side in the conveyance direction, and the left side in FIG. 1 is the downstream side in the conveyance direction.

The conveyance device B includes a plurality of conveyance mechanisms B1 and B2. Each of the conveyance mechanisms B1 and B2 is configured by, for example, a belt conveyor, a roller conveyor, or the like, and includes an upstream conveyance mechanism B1 and a downstream conveyance mechanism B2. The upper surfaces of the upstream conveyance mechanism B1 and the downstream conveyance mechanism B2 are conveyance surfaces. In this embodiment, a conveyance direction of the workpiece W is defined as a Y direction, a direction orthogonal to the Y direction on the conveyance surface is defined as an X direction, and a direction orthogonal to both the X direction and the Y direction is defined as a Z direction. In the distribution site, the X direction and the Y direction are often substantially horizontal, but the Y direction may be inclined with respect to a horizontal plane. The X direction can be referred to as a width direction of the conveyance mechanisms B1 and B2, or can be referred to as a longitudinal direction of the gap of the conveyance device B. In addition, the Z direction can also be referred to as a height direction (up-down direction). Note that the definition of the direction is a definition for convenience of description, and does not limit the direction at the time of use.

The upstream conveyance mechanism B1 and the downstream conveyance mechanism B2 are provided at intervals in the conveyance direction. The size (dimension) of the interval between the upstream conveyance mechanism B1 and the downstream conveyance mechanism B2 is not particularly limited, but is set so that the smallest workpiece W to be conveyed is smoothly transferred from the upstream conveyance mechanism B1 to the downstream conveyance mechanism B2 without falling from the gap. The dimension (dimension in the X direction) of the gap in the longitudinal direction is about the same as the width (dimension in the X direction) of the conveyance mechanisms B1 and B2, but this is also not particularly limited.

The upstream conveyance mechanism B1 and the downstream conveyance mechanism B2 are supported on a floor surface C (illustrated in FIG. 2) by members such as leg portions B3, for example. Therefore, since the conveyance surfaces of the upstream conveyance mechanism B1 and the downstream conveyance mechanism B2 are positioned at positions separated upward from the floor surface C by a predetermined dimension, a space may be formed below the upstream conveyance mechanism B1 and the downstream conveyance mechanism B2.

Although FIGS. 1 and 2 illustrate an example in which four code readers 1A, 1B, 1C, and 1D are used at the time of operation, the number of code readers at the time of operation is not limited to four, and may be any number of three or less, or five or more. The code reader 1A is referred to as a first code reader 1A, the code reader 1B is referred to as a second code reader 1B, the code reader 1C is referred to as a third code reader 1C, and the code reader 1D is referred to as a fourth code reader 1D.

The first to fourth code readers 1A, 1B, 1C, and 1D are configured to be usable in a state of being attached to an external frame (hereinafter, simply referred to as a frame) 830, and are stationary code readers that read a code attached to the workpiece W conveyed by the conveyance device B. The operation time of the stationary code readers 1A, 1B, 1C, and 1D is a time when an operation of sequentially reading the code of the workpiece W conveyed by the conveyance device B is performed.

The frame 830 is a frame-shaped frame formed so as to surround the conveyance device B, and includes a lower member 831 disposed below the conveyance device B and extending in the width direction (X direction) of the conveyance device B, a pair of side members 832 extending upward (Z direction) from both sides of the lower member 831 in the longitudinal direction, and an upper member 833 extending in the width direction of the conveyance device B so as to connect upper ends of the pair of side members 832. The frame 830 is fixed to, for example, a floor surface C (illustrated in FIG. 2) or the like.

A housing 60 of the first code reader 1A for reading a code attached to the bottom surface of the workpiece W is attached to the lower member 831 via a bracket 810. Since the lower member 831 is located below the conveyance surface of the conveyance device B, the installation position of the first code reader 1A attached to the lower member 831 is below the conveyance surface of the conveyance device B. The optical axis of the first code reader 1A attached to the lower member 831 faces upward, and the visual field of the first code reader 1A includes a gap between the upstream conveyance mechanism B1 and the downstream conveyance mechanism B2.

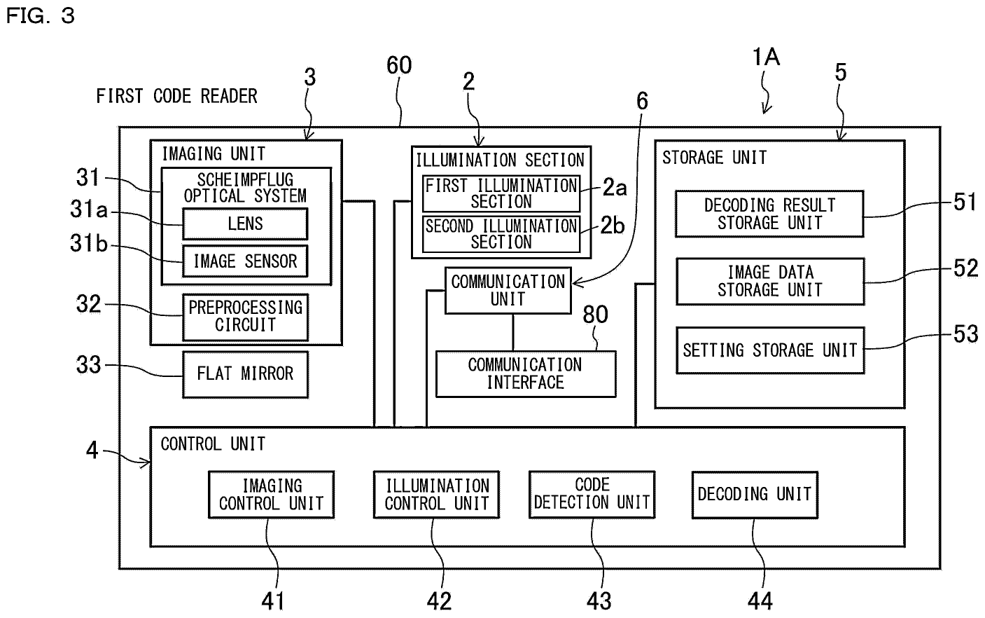

Since the gap between the upstream conveyance mechanism B1 and the downstream conveyance mechanism B2 is included in the visual field range of the first code reader 1A, when the bottom surface of the workpiece W being conveyed passes through the gap between the upstream conveyance mechanism B1 and the downstream conveyance mechanism B2, the bottom surface can be captured by the imaging unit 3 (illustrated in FIG. 3) of the first code reader 1A. A code may be attached to the bottom surface of the workpiece W. In a case where the code is attached to the bottom surface of the workpiece W, since the first code reader 1A is installed at the installation position below the conveyance surface of the conveyance device B, the code attached to the bottom surface of the workpiece W can be read from below the conveyance surface of the conveyance device B through the gap between the upstream conveyance mechanism B1 and the downstream conveyance mechanism B2.

The second code reader 1B for reading a code attached to one side surface of the workpiece W is attached to the one side member 832 via a bracket (not illustrated) similar to the first code reader 1A. The optical axis of the second code reader 1B attached to the one side member 832 is set to face one side surface of the workpiece W.

A housing 60 of the third code reader 1C for reading a code attached to the other side surface of the workpiece W is attached to the other side member 832 via a bracket 810 similar to the first code reader 1A. The optical axis of the third code reader 1C attached to the other side member 832 is set to face the other side surface of the workpiece W.

A housing 60 of the fourth code reader 1D for reading a code attached to the upper surface of the workpiece W is attached to the upper member 833 via a bracket 810 similar to the first code reader 1A. The optical axis of the fourth code reader 1D attached to the upper member 833 faces downward.

The structure of the frame 830 is an example, and may not be a frame-shaped frame. For example, the frame may be any of a frame including only the lower member 831, a frame including only the side member 832, and a frame including only the upper member 833. In addition, the frame may include any two of the lower member 831, the side member 832, and the upper member 833. In addition, the code reader may not be attached to all of the lower member 831, the side member 832, and the upper member 833, and the code reader may be attached to any one of the lower member 831, the side member 832, and the upper member 833, or any two or more of them. In addition, the frame may be fixed to, for example, the conveyance device B, another member, equipment, or the like. In addition, the shape of the frame may be linear, or may be curved or bent.

The code attached to the workpiece W includes both a barcode and a two-dimensional code. Examples of the two-dimensional code include a QR code (registered trademark), a micro QR code, and a data matrix (Data code), Veri code, Aztec code, PDF417, Maxi code, and the like. The two-dimensional code includes a stack type and a matrix type, but the invention can be applied to any two-dimensional code. The code may be attached by directly printing or imprinting the code on the workpiece W, or may be attached by attaching the code to the workpiece W after printing the code on a label, and the way and method therefor are not limited.

As illustrated in FIG. 1, the first to fourth code readers 1A, 1B, 1C, and 1D are connected to the computer 200 and the programmable logic controller (PLC) 201 by wires via the signal lines 200a and 201a, respectively. However, the invention is not limited to this. A wireless communication module may be incorporated in the first to fourth code readers 1A, 1B, 1C, and 1D, the computer 200, and the PLC 201, and the first to fourth code readers 1A, 1B, 1C, and 1D may be wirelessly connected to the computer 200 and the PLC 201. The PLC 201 is a control device for sequence controlling the conveyance device B and the first to fourth code readers 1A, 1B, 1C, and 1D, and a general-purpose PLC can be used. As the computer 200, a general-purpose or dedicated electronic computer, a portable terminal, or the like can be used.

In addition, the first to fourth code readers 1A, 1B, 1C, and 1D receive a reading start trigger signal that defines a start timing of code reading from the PLC 201 via the signal line 201a at the time of operation. Then, the first to fourth code readers 1A, 1B, 1C, and 1D execute code imaging and decoding processing on the basis of the reading start trigger signal. Thereafter, the decoding result of the decoding processing is transmitted to the PLC 201 via the signal line 201a. As described above, during the operation of the first to fourth code readers 1A, 1B, 1C, and 1D, the input of the reading start trigger signal and the output of the decoding result are repeatedly performed via the signal line 201a between the first to fourth code readers 1A, 1B, 1C, and 1D and the external control device such as the PLC 201. Note that the input of the reading start trigger signal and the output of the decoding result may be performed via the signal line 201a between the first to fourth code readers 1A, 1B, 1C, and 1D and the PLC 201 as described above, or may be performed via other signal lines (not illustrated). For example, a sensor for detecting the arrival of the workpiece W and the first to fourth code readers 1A, 1B, 1C, and 1D may be directly connected, and the reading start trigger signal may be input from the sensor to the first to fourth code readers 1A, 1B, 1C, and 1D.

The first to fourth code readers 1A, 1B, 1C, and 1D are the same. Hereinafter, the first code reader 1A will be described in detail with reference to FIG. 3. The first code reader 1A includes an illumination section 2, an imaging unit 3, a control unit 4, a storage unit 5, a communication unit 6, a flat mirror 33, and a housing 60. The illumination section 2, the imaging unit 3, the control unit 4, the storage unit 5, the communication unit 6, and the flat mirror 33 are stored in the housing 60.

The control unit 4 includes an imaging control unit 41 that controls the imaging unit 3, an illumination control unit 42 that controls the illumination section 2, a code detection unit 43, and a decoding unit 44. In addition, the storage unit 5 can be configured by a readable/writable storage device such as a solid state drive (SSD). The storage unit 5 can store, for example, various programs, decoding results, image data, setting information, and the like, and includes a decoding result storage unit 51, an image data storage unit 52, and a setting storage unit 53. Although not illustrated, the decoding result storage unit 51, the image data storage unit 52, and the setting storage unit 53 may be provided in separate storage devices.

The communication unit 6 executes communication with the computer 200 and the PLC 201. The setting information by the computer 200 is received by the control unit 4 via the communication unit 6. In addition, the control unit 4 receives the reading start trigger signal from the PLC 201 via the communication unit 6. Information on the decoding result by the first code reader 1A is transmitted to the computer 200 or the PLC 201 via the communication unit 6. In addition, the communication unit 6 receives, for example, the dimension of the gap formed between the plurality of conveyance mechanisms B1 and B2 of the conveyance device B, the conveyance speed of the conveyance device B, and the like. The user can input the dimension of the gap and the conveyance speed to the computer 200 or the like in advance. The dimension of the gap and the conveyance speed input are stored in the computer 200, and the dimension of the gap and the conveyance speed are received and acquired by the communication unit 6 after being transmitted from the computer 200.

The illumination section 2 is a portion that irradiates the workpiece W with illumination light. In a case where the first code reader 1A is attached to the lower member 831 of the frame 830, the irradiation range of the illumination light of the illumination section 2 includes a gap between the upstream conveyance mechanism B1 and the downstream conveyance mechanism B2. In this case, since the first code reader 1A is installed below the conveyance surface of the conveyance device B, the illumination section 2 emits illumination light from below the conveyance surface toward the gap. As a result, when the bottom surface of the workpiece W being conveyed passes through the gap between the upstream conveyance mechanism B1 and the downstream conveyance mechanism B2, the bottom surface can be illuminated by the illumination section 2. In a case where the code is attached to the bottom surface of the workpiece W, the code attached to the bottom surface of the workpiece W can be illuminated by the illumination section 2.

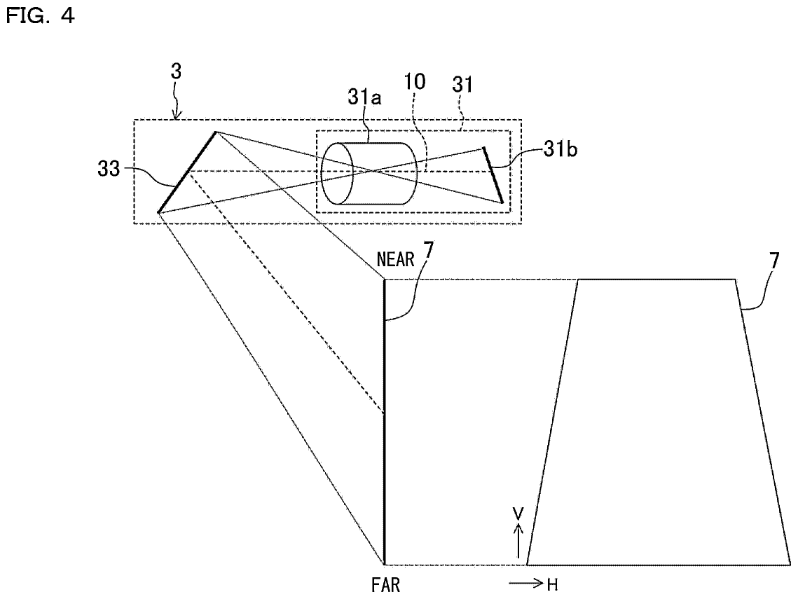

Although not an essential configuration, the illumination section 2 includes a first illumination section 2a and a second illumination section 2b. The first illumination section 2a and the second illumination section 2b are portions that irradiate the focal plane 5 (illustrated in FIG. 4) of the Scheimpflug optical system 31 to be described later with illumination light. The first illumination section 2a and the second illumination section 2b include a light emitter including, for example, a light emission diode (LED) or the like. The illumination section 2 may include a single illumination section without including the first illumination section 2a and the second illumination section 2b. Note that it is not essential to include the Scheimpflug optical system 31, and the invention can also be applied to a case where the Scheimpflug optical system 31 is not included.

The illumination section 2 and the imaging unit 3 may be integrated, or the illumination section 2 and the imaging unit 3 may be separated. The illumination section 2 is controlled by the illumination control unit 42 to switch on and off, change brightness at the time of lighting, and the like. When the reading start trigger signal is input from the PLC 201, the illumination control unit 42 turns on the illumination section 2 for a predetermined time and turns off the illumination section 2 after the predetermined time has elapsed.

The imaging unit 3 is a portion that captures an image of the workpiece W through the gap between the upstream conveyance mechanism B1 and the downstream conveyance mechanism B2, generates a code image including a code, and outputs the code image to the control unit 4. Further, the imaging unit 3 of each of the second to fourth code readers 1B to 1D is a portion that captures an image of the workpiece W from above the conveyance surface of the conveyance mechanism B, generates a code image including a code, and outputs the code image to the control unit 4. The imaging unit 3 includes a Scheimpflug optical system 31 and a preprocessing circuit 32. As also illustrated in FIG. 4, the Scheimpflug optical system 31 includes a lens 31a and an image sensor 31b having a two-dimensional light receiving surface inclined with respect to the optical axis 10 of the lens 31a. The lens 31a is an imaging lens that collects reflected light from the bottom surface of the workpiece W. The light incident on the lens 31a is emitted toward the light receiving surface of the image sensor 31b and forms an image on the light receiving surface, whereby an image corresponding to the code attached to the workpiece W is projected on the light receiving surface of the image sensor 31b.

In this example, since the Scheimpflug optical system 31 is provided, the focal plane 7 is formed to extend in the V direction of the image sensor 31b, and the focal plane 7 is inclined in the V direction of the image sensor 31b.

The image sensor 31b includes a light receiving element such as a charge-coupled device (CCD) or a complementary metal oxide semiconductor (CMOS) that converts an image of a code obtained through the lens 31a into an electrical signal. An image including a code is generated on the basis of the amount of light received by the light receiving surface of the image sensor 31b. The image sensor 31b includes a plurality of imaging elements arranged in a row direction and a column direction, and is configured such that the row direction substantially coincides with a direction from the near side to the far side of the focal plane of the Scheimpflug optical system 31. An aspect ratio of the image sensor 31b is set to be smaller than an aspect ratio of a light receiving window 622 to be described later. Then, the image sensor 31b is configured to be able to partially output a signal from an imaging element corresponding to the light receiving window 622 among the plurality of imaging elements.

That is, assuming a case where a line sensor is used as an image sensor, high-speed reading is possible, but there is a risk that the frame rate becomes extremely high in order to read a code, and the calorific value of the illumination section 2 increases. In this regard, in the present embodiment, an area sensor in which a plurality of imaging elements is arranged in the row direction and the column direction is used as the image sensor 31b, and only a portion (a partial row) corresponding to the light receiving window 622 is partially read, so that it is possible to achieve both heat generation suppression and high-speed reading.

The image generated by the image sensor 31b is input to the preprocessing circuit 32. The preprocessing circuit 32 may be provided as necessary, and is not essential.

The preprocessing circuit 32 includes, for example, an integrated circuit such as a field programmable gate array (FPGA), and is a portion that executes various preprocessing on an image output from the image sensor 31b. The preprocessing includes, for example, various kinds of filtering. The imaging unit 3 outputs the image preprocessed by the preprocessing circuit 32 to the control unit 4. The preprocessing by the preprocessing circuit 32 may be executed as necessary, and an image on which the preprocessing is not executed may be output to the control unit 4. The image output to the control unit 4 is stored in the image data storage unit 52 included in the storage unit 5.

The imaging unit 3 is controlled by the imaging control unit 41. When the reading start trigger signal is input from the PLC 201, the imaging control unit 41 generates an image by performing exposure for a preset exposure time. The imaging control unit 41 also executes processing, as necessary, of applying a preset gain to an image generated by the image sensor 31b and amplifying the brightness of the image by digital image processing by controlling the imaging unit 3. In addition, the imaging control unit 41 determines the frame rate (the number of times of imaging per second) of the imaging unit 3 on the basis of the dimension (width of the gap) of the gap between the conveyance mechanisms B1 and B2 received by the communication unit 6 and the conveyance speed. For example, the imaging control unit 41 increases the frame rate of the imaging unit 3 as the conveyance speed increases. The frame rate can be set in a range of 500 fps to 5000 fps, for example. As the frame rate increases, stronger light is required to obtain sufficient brightness in a short exposure time, so that the calorific value of the illumination section 2 also increases proportionally. Since the second to fourth code readers 1B to 1D do not perform capturing an image through the gap between the conveyance mechanisms B1 and B2, it is not necessary to determine the frame rate based on the dimension of the gap between the conveyance mechanisms B1 and B2.

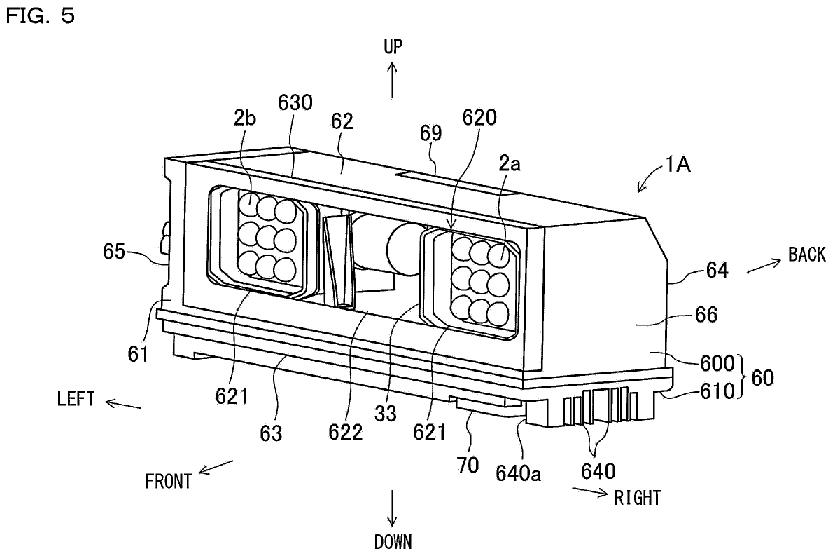

As illustrated in FIGS. 5 to 7, the first code reader 1A includes a housing 60 that stores the illumination section 2, the imaging unit 3, and the control unit 4. The housing 60 may store the imaging unit 3 and the control unit 4 and may not store the illumination section 2. In this case, the illumination section 2 is an illumination section configured separately from the housing 60 that stores the imaging unit 3 and the control unit 4, but is controlled in synchronization by the control unit 4 when capturing an image of the workpiece W. The illumination section configured separately from the housing 60 is also referred to as an external illumination section.

The housing 60 has a long shape along a predetermined direction (first direction). As illustrated in FIG. 2, the first code reader 1A and the fourth code reader 1D are installed such that the first direction is the horizontal direction (X direction). On the other hand, the second code reader 1B and the third code reader 1C are installed such that the first direction is the up-down direction (Z direction). As described above, the installation posture of the code readers 1A, 1B, 1C, and 1D can be set according to the structure of the conveyance device B, which surface of the workpiece W the code is to be read, and the like, and is not limited to the illustrated posture, and may be, for example, a posture inclined with respect to the X direction or a posture inclined with respect to the Z direction.

The housing 60 has a first side surface 61, a second side surface 62, a third side surface 63, and a fourth side surface 64, and also has a first end surface 65 and a second end surface 66. In this embodiment, the depth direction (front-rear direction), the left-right direction, and the up-down direction of the housing 60 are defined as illustrated in FIGS. 5 to 7, but this definition is for convenience of description and does not limit the actual use posture of the first code reader 1A. Actually, there may be a case where installation is performed in a posture in which the up-down direction is reversed or installation is performed such that the up-down direction is the horizontal direction, and each direction in the following description can be replaced in consideration of the posture at the time of actual installation. In the case illustrated in FIGS. 5 to 7, the first direction is the left-right direction. Therefore, the dimension of the housing 60 in the left-right direction is longer than the dimensions of the housing 60 in the up-down direction and the depth direction. In addition, the number of side surfaces of the housing 60 is not limited to six, and may be a shape having six or more side surfaces.

According to the above definition, the first side surface 61 is a surface (front surface) located on the front side of the housing 60, and has a shape elongated in the left-right direction. The second side surface 62 is a side surface adjacent to the first side surface 61, extends toward the back side from the upper edge portion (one edge portion) of the first side surface 61 and also extends in the left-right direction, and is a surface (upper surface) located on the upper side of the housing 60. The third side surface 63 is a side surface adjacent to the first side surface 61, extends toward the back side from the lower edge portion (other edge portion) of the first side surface 61 and also extends in the left-right direction, and is a surface (lower surface) located on the lower side of the housing 60. The fourth side surface 64 is a side surface located opposite to the first side surface 61, extends in the up-down direction from the edge portion on the back side of the second side surface 62 to the edge portion on the back side of the third side surface and also extends in the left-right direction, and is a surface (rear surface) located on the rear side of the housing 60. The first side surface 61 and the fourth side surface 64 are substantially parallel to each other. In addition, the second side surface 62 and the third side surface 63 are substantially parallel to each other.

The first end surface 65 is a left end surface of the housing 60, and extends in the depth direction and the up-down direction. The second end surface 66 is a right end surface of the housing 60, and extends in the depth direction and the up-down direction. The first end surface 65 and the second end surface 66 are substantially parallel to each other.

The housing 60 includes a box-shaped case 600 constituting a part of the housing 60 and a lid-shaped case 610 constituting another part of the housing 60, and the box-shaped case 600 and the lid-shaped case 610 are integrated to form the housing 60. The lid-shaped case 610 is a first housing constituent member, and the box-shaped case 600 is a second housing constituent member.

The box-shaped case 600 is a member constituting the first side surface 61, the second side surface 62, the fourth side surface 64, the first end surface 65, and the second end surface 66, and is made of resin obtained by molding a resin material. The box-shaped case 600 is a member constituting a portion other than the third side surface 63, and thus has a shape in which the third side surface 63 side is opened. The lid-shaped case 610 is a member constituting the third side surface 63 and is made of metal. Examples of the metal material constituting the lid-shaped case 610 include a metal material having a high heat transfer coefficient such as an aluminum alloy. Therefore, the lid-shaped case 610 is more excellent in heat dissipation than the box-shaped case 600. On the other hand, the resin material constituting the box-shaped case 600 is inferior in heat dissipation to the metal material constituting the lid-shaped case 610, but has a low specific gravity. Therefore, it is possible to reduce the weight of the box-shaped case 600.

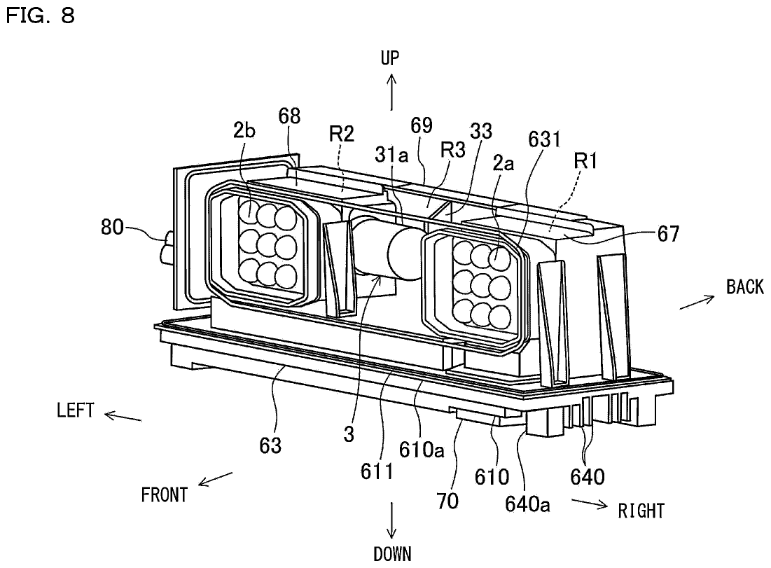

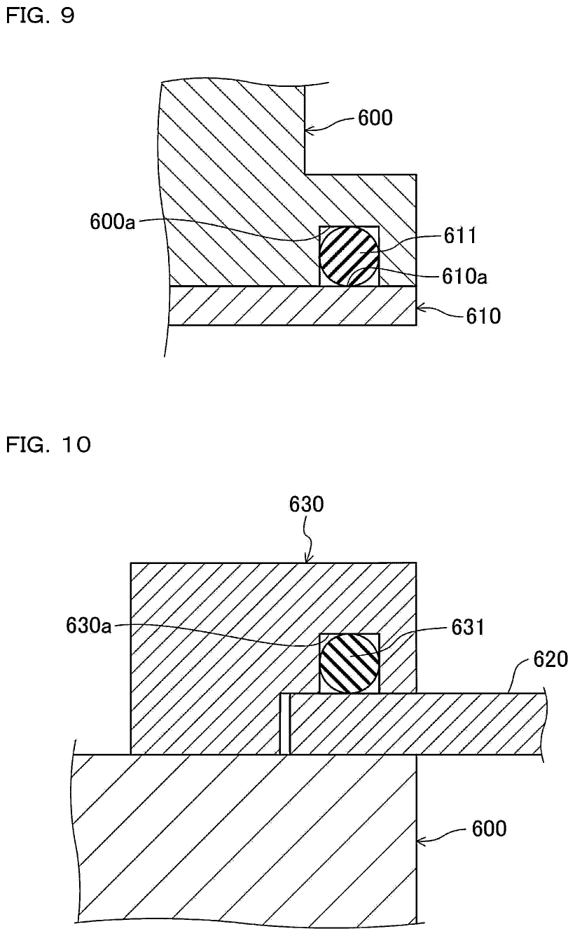

The lid-shaped case 610 is attached to the box-shaped case 600 so as to cover the opened portion of the box-shaped case 600. FIG. 8 illustrates a state in which the box-shaped case 600 is removed, and as illustrated in this drawing, a main packing 611 made of an elastic material made of, for example, rubber, thermoplastic elastomer, or the like is disposed on a joint surface 610a with the box-shaped case 600 in the lid-shaped case 610. The main packing 611 is formed in an annular shape along the peripheral edge portion of the lid-shaped case 610, and is held in a state of being stored in a groove 600a formed in the box-shaped case 600 as illustrated in FIG. 9. Since the groove 600a of the box-shaped case 600 is a portion for storing the annular main packing 611, the groove has an annular shape similarly to the main packing 611 and is opened to the lid-shaped case 610 side. Further, although not illustrated, the groove for storing the main packing 611 may be formed in the lid-shaped case 610.

The main packing 611 stored in the groove 600a is in close contact with the joint surface 610a of the lid-shaped case 610 in a state where the lid-shaped case 610 is integrated with the box-shaped case 600. As a result, a space between the box-shaped case 600 and the lid-shaped case 610 is sealed by the main packing 611, and external water or the like does not enter the inside of the housing 60.

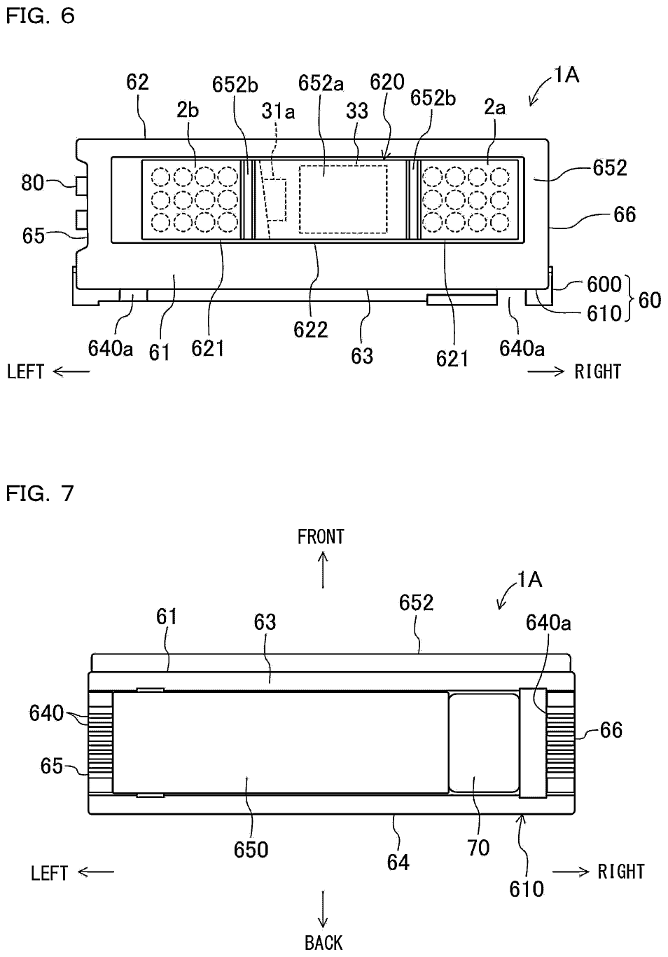

As illustrated in FIGS. 5 and 6, the first side surface 61 of the box-shaped case 600 is provided with a light transmitting member 620 that transmits light such as reflected light from the workpiece W and illumination light emitted from the illumination section 2. The light transmitting member 620 is a member constituting a light projecting window 621 that transmits the illumination light emitted from the illumination section 2 to the outside of the housing 60 and a light receiving window 622 that transmits the reflected light from the workpiece W to the inside of the housing 60. Since the light projecting window 621 and the light receiving window 622 are formed of the common light transmitting member 620, the number of components can be reduced. In addition, since the first side surface 61 is one side surface of the housing 60, the housing 60 is a member having the light projecting window 621 and the light receiving window 622 on the side.

The light transmitting member 620 forms a plane extending along the left-right direction and the up-down direction of the housing 60. The plane formed by the light transmitting member 620 can also be defined as a virtual plane including the front surface (or back surface) of the light transmitting member 620. Note that the light transmitting member 620 may not be a perfect plane, and may be a surface that is curved so as to be optically flat.

The light transmitting member 620 has a long shape along the longitudinal direction of the housing 60. The light transmitting member 620 is not particularly limited, but is made of, for example, acrylic, glass, polycarbonate, or the like. Note that the light projecting window 621 and the light receiving window 622 may be configured as separate members.

As illustrated in FIG. 5, a window frame member 630 for fixing the light transmitting member 620 to the first side surface 61 of the box-shaped case 600 is provided on the first side surface 61 of the box-shaped case 600. The window frame member 630 has a rectangular shape that is long in the left-right direction so as to correspond to the outer shape of the light transmitting member 620.

A window frame packing 631 (illustrated in FIG. 8) made of the same material as the main packing 611 is disposed on a joint surface (not shown) of the window frame member 630 with the box-shaped case 600. The window frame packing 631 is annularly formed along a peripheral edge portion of the window frame member 630, and is held in a state of being stored in a groove 630a formed in the window frame member 630 as illustrated in FIG. 10. Since the groove 630a of the window frame member 630 is a portion that stores the annular window frame packing 631, the groove has an annular shape similarly to the window frame packing 631 and is opened toward the box-shaped case 600 side. Further, although not illustrated, the groove for storing the window frame packing 631 may be formed in the box-shaped case 600.

The window frame packing 631 stored in the groove 630a is in close contact with the outer surface of the light transmitting member 620 in a state where the window frame member 630 is integrated with the box-shaped case 600. As a result, a space between the light transmitting member 620 and the window frame member 630 is sealed by the window frame packing 631, and external water or the like does not enter the inside of the housing 60 from the window frame member 630.

The first illumination section 2a is stored on the right side of the central portion in the left-right direction of the housing 60. The second illumination section 2b is stored on the left side of the central portion in the left-right direction of the housing 60. That is, the illumination section 2 includes the first illumination section 2a and the second illumination section 2b arranged apart from each other in the longitudinal direction of the housing 60.

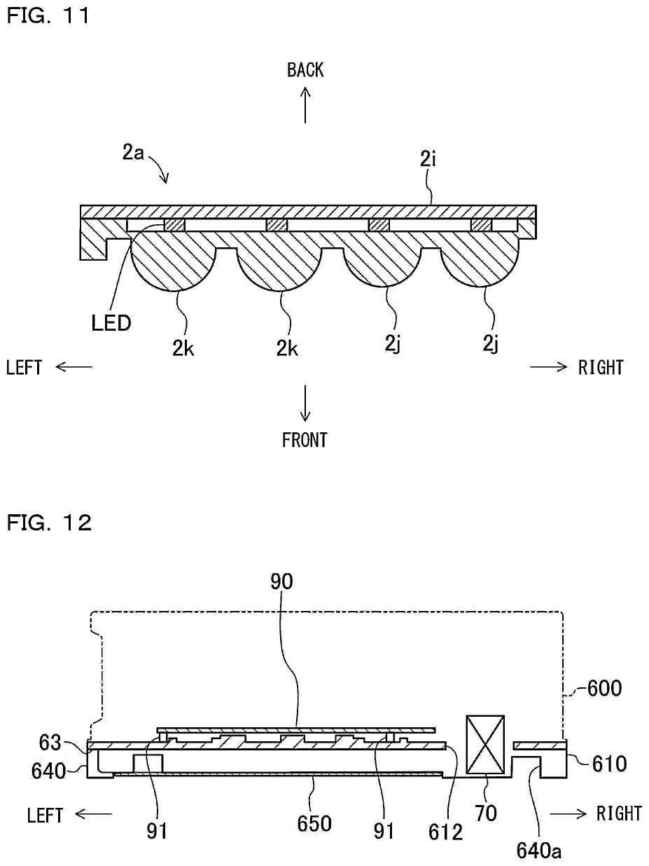

As illustrated in FIG. 11, the first illumination section 2a includes a light emitting substrate 2i on which a plurality of LEDs are mounted, a wide-angle illumination lens 2j, and a narrow-angle illumination lens 2k. The light emitting substrate 2i extends in the left-right direction and the up-down direction. The plurality of LEDs is mounted in a matrix on the front surface of the light emitting substrate 2i at intervals in the left-right direction and the up-down direction. The wide-angle illumination lens 2j and the narrow-angle illumination lens 2k are attached to a common light emitting substrate 2i. The plurality of wide-angle illumination lenses 2j and the plurality of narrow-angle illumination lenses 2k are integrally molded so as to protrude in the optical axis direction, and are formed of one member.

The wide-angle illumination lens 2j is arranged so as to correspond to the plurality of LEDs mounted on the right side of the light emitting substrate 2i, and is formed at a wide angle so as to be capable of irradiating a wide range with light from the LEDs. The wide-angle illumination lens 2j and the LED corresponding to the wide-angle illumination lens 2j constitute a first irradiation angle illumination section in which the spread of the irradiation light is a first irradiation angle.

The narrow-angle illumination lens 2k is arranged so as to correspond to the plurality of LEDs mounted on the left side of the light emitting substrate 2i, and is formed to have a narrow angle so that illumination light can be emitted to a narrower range than the wide-angle illumination lens 2j. The narrow-angle illumination lens 2k and the LED corresponding to the narrow-angle illumination lens 2k constitute a second irradiation angle illumination section in which the spread of the irradiation light has a second irradiation angle wider than the first irradiation angle. Then, the wide-angle illumination lens 2j and the LEDs corresponding to the wide-angle illumination lens 2j, and the narrow-angle illumination lens 2k and the LEDs corresponding to the narrow-angle illumination lens 2k are arranged in the longitudinal direction of the housing 60.

The dimension of the narrow-angle illumination lens 2k in the optical axis direction is set to be longer than the dimension of the wide-angle illumination lens 2j in the optical axis direction. In addition, the dimension in the radial direction at the base of the narrow-angle illumination lens 2k is set to be shorter than the dimension in the radial direction at the base of the wide-angle illumination lens 2j. The second illumination section 2b is bilaterally symmetrical with the first illumination section 2a. That is, in the longitudinal direction of the housing 60, the narrow-angle illumination lens 2k is arranged on the outer side (a position far from the imaging unit 3 located at the center), and the wide-angle illumination lens 2j is arranged on the inner side. As a result, the illumination distribution in the longitudinal direction of the housing 60 is made more uniform.

Since the first illumination section 2a is stored on the right side of the housing 60, the first illumination section 2a is arranged side by side with the light receiving window 622 along the first direction to form the irradiation surface (which becomes the surface of the light projecting window 621) for irradiating the workpiece W with the illumination light. In addition, since the second illumination section 2b is stored on the left side of the housing 60, the second illumination section 2b also is arranged side by side with the light receiving window 622 along the first direction to form the irradiation surface (which becomes the surface of the light projecting window 621) for irradiating the workpiece W with the illumination light.

As illustrated in FIG. 8, a first light shielding member 67 forming a first light projecting room R1 in which the first illumination section 2a is stored and a second light shielding member 68 forming a second light projecting room R2 in which the second illumination section 2b is stored are provided in the housing 60. The first light shielding member 67 is made of, for example, a resin material having a light shielding property, is stored on the right side in the housing 60, and is formed so as to surround the first illumination section 2a. The second light shielding member 68 is made of a material similar to the material of the first light shielding member 67, is stored on the left side in the housing 60, and is formed so as to surround the second illumination section 2b.

Since the illumination light emitted from the first illumination section 2a is blocked by the first light shielding member 67, it is possible to suppress incidence of the illumination light on the lens 31a of the imaging unit 3. In addition, since the illumination light emitted from the second illumination section 2b is blocked by the second light shielding member 68, it is possible to suppress incidence of the illumination light on the lens 31a of the imaging unit 3.

The housing 60 includes a light receiving room R3 configured by a portion other than the first light projecting room R1 and the second light projecting room R2 in the housing 60. That is, since the light receiving room R3 is configured by the outer space of the first light shielding member 67 and the second light shielding member 68 in the housing 60, the light receiving room R3 is a room optically isolated from the illumination sections 2a and 2b.

In the light receiving room R3, the imaging unit 3 and the flat mirror 33 are stored. The imaging unit 3 is disposed on the back side of the second illumination section 2b in the housing 60. The image sensor 31b is installed in the housing 60 in the longitudinal direction of the housing 60, which is the first direction. In this embodiment, since the image sensor 31b is stored on the left side of the housing 60, the light receiving surface of the image sensor 31b faces to the right. Note that the imaging unit 3 may be disposed on the back side of the first illumination section 2a in the housing 60. In this case, the image sensor 31b may be disposed such that the light receiving surface faces left.

Since the light receiving surface of the image sensor 31b faces the right side, the optical axis of the lens 31a is directed in the left-right direction, the side on which light enters the lens 31a is the right side, and the side on which light exits from the lens 31a is the left side. The lens 31a is also disposed on the back side of the second illumination section 2b, and is positioned on the right side of the image sensor 31b.

The flat mirror 33 is a member for turning back an optical path corresponding to the visual field of the imaging unit 3 in the direction of the light receiving window 622 in the housing 60. Specifically, the flat mirror 33 is disposed between the first illumination section 2a and the second illumination section 2b. The flat mirror 33 extends in the up-down direction and is inclined with respect to the longitudinal direction of the housing 60 so as to be located on the right as going toward the front side. The inclined arrangement of the flat mirror 33 enables the optical path corresponding to the visual field of the imaging unit 3 to be turned back in the direction of the light receiving window 622. In the present embodiment, the reflected light reflected from the workpiece W passes through the light receiving window 622 and then enters the flat mirror 33. The light incident on the flat mirror 33 is configured to be emitted toward the lens 31a of the imaging unit 3.

As illustrated in FIGS. 6 and 7, the housing 60 is provided with a polarizing filter attachment 652 so as to cover the light transmitting member 620. The polarizing filter attachment 652 is attachable to and detachable from the housing 60, and can be used as necessary. FIG. 5 illustrates a state in which the polarizing filter attachment 652 is removed.

The polarizing filter attachment 652 is provided with a polarizing filter 652a having a polarizing film or the like so as to face the light transmitting member 620. Between the polarizing filter 652a and the light transmitting member 620, a light shielding material 652b for suppressing the illumination light emitted from the first illumination section 2a and the second illumination section 2b from entering the optical system 31 of the imaging unit 3 is provided.

As illustrated in FIGS. 5 and 8, the housing 60 is arranged to face the outside of the housing 60, forms a part of the light receiving room R3, and includes an indicator 69 that emits light on the basis of the processing result of the decoding unit 44. The indicator 69 is controlled by the control unit 4, and emits light in a first color in a case where a decoding result by the decoding unit 44 is normally obtained, and emits light in a second color different from the first color when an error occurs. Since the indicator 69 forms a part of the light receiving room R3, light of the part of the indicator 69 may enter the light receiving room R3. On the other hand, in the present embodiment, the control unit 4 executes turning-off control to turn off the indicator 69 at least during exposure by the imaging unit 3. For example, by turning off the indicator 69 from the start to the end of the exposure of the imaging unit 3, it is possible to prevent the light of the indicator 69 from affecting the image generated by the imaging unit 3.

A plurality of heat dissipation fins 640 extending in the left-right direction are provided on the third side surface 63 side of the lid-shaped case 610. Since the longitudinal direction of the light transmitting member 620 is the left-right direction, the longitudinal direction of the heat dissipation fin 640 coincides with the longitudinal direction of the light transmitting member 620. The plurality of heat dissipation fins 640 are formed at intervals in the depth direction (width direction) of the housing 60. The heat dissipation fin 640 is made of the same material as the portion constituting the second side surface 62, and thus has a high heat transfer coefficient.

As illustrated in FIG. 7, the housing 60 is provided with a cover portion 650 that covers the tip portions of the plurality of heat dissipation fins 640. Since the cover portion 650 covers the tip portions of the plurality of heat dissipation fins 640, an air passage extending along the longitudinal direction of the light transmitting member 620 is formed by the third side surface 63 of the housing 60, a space between the plurality of heat dissipation fins 640, and the cover portion 650.

The first code reader 1A includes a fan 70 for blowing air in the longitudinal direction of the heat dissipation fin 640. The heat dissipation fin 640 is located in a portion forcibly blown by the fan 70.

The heat dissipation fins 640 are discontinuous in the longitudinal direction of the heat dissipation fins 640. Specifically, a cutout portion 640a is formed by cutting out a middle portion of the heat dissipation fin 640 in the longitudinal direction. As a result, since the heat dissipation fins 640 are provided intermittently in the left-right direction, for example, even if the air passage is closed by the end portions of the heat dissipation fins 640 in the left-right direction being in close contact with any member, the air blown into the air passage can flee to the outside from the cutout portions 640a, and a decrease in cooling efficiency can be suppressed.

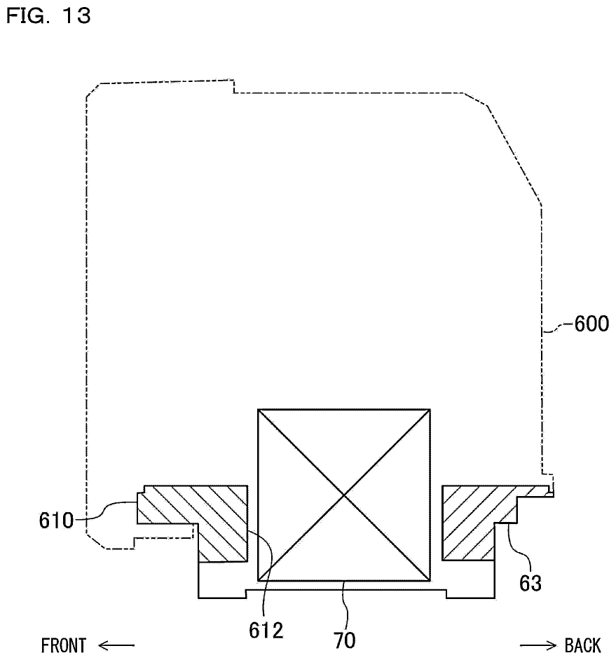

As illustrated in FIGS. 12 and 13, a through hole 612 penetrating the lid-shaped case 610 in the inner and outer directions is provided in a portion of the lid-shaped case 610 where the fan 70 is disposed. A part of the fan 70 attached to the lid-shaped case 610 protrudes into the housing 60 while being stored in the through hole 612. As a result, it is possible to reduce the amount of downward protrusion of the fan 70 while adopting the large-diameter fan 70, and as a result, it is possible to shorten the dimension of the first code reader 1A in the up-down direction.

In addition, as illustrated in FIG. 12, the control board 90 provided with the control unit 4 is attached to the lid-shaped case 610 via an attachment member 91. The attachment member 91 is, for example, a member having heat transferability similarly to the lid-shaped case 610. Since the control unit 4 is a portion that executes decoding processing of the code attached to the workpiece W on the basis of the image generated by the image sensor 31b, the temperature rises during operation. By interposing the attachment member 91, heat of the control board 90 can flee to the lid-shaped case 610 and released by the heat dissipation fins 640.

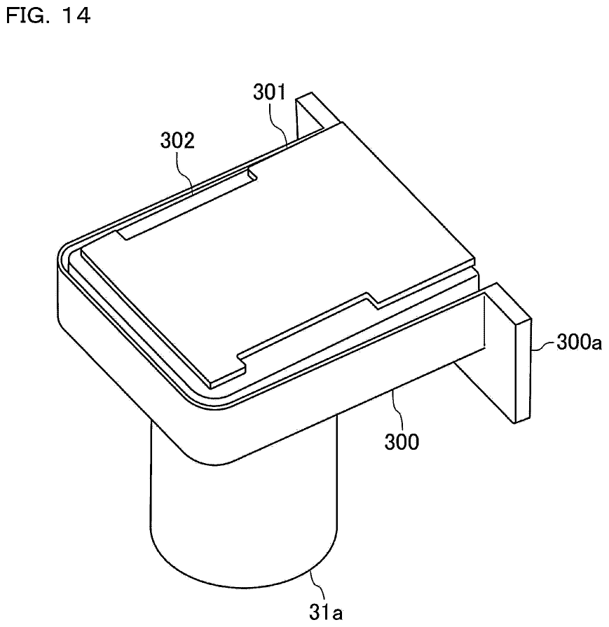

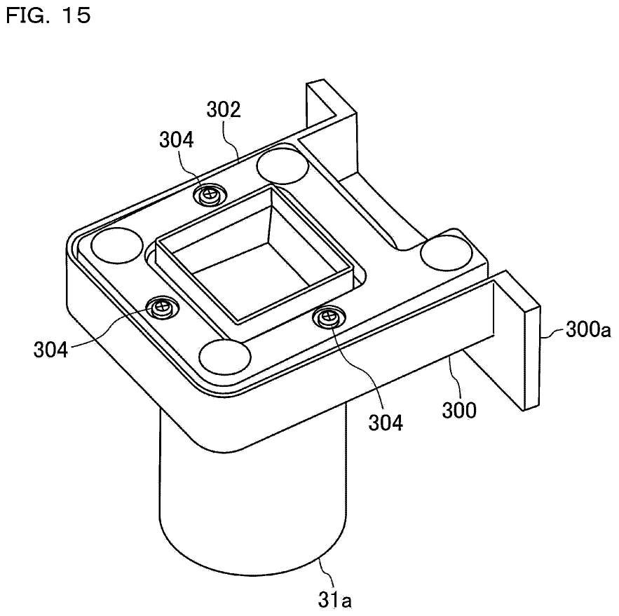

FIGS. 14 to 16 illustrate a lens holder 300 that holds the lens 31a of the imaging unit 3, and the lens holder 300 has a fixing portion 300a fixed to the lid-shaped case 610 and has a tilt adjustment mechanism of the image sensor 31b. Specifically, a sensor substrate 301 as illustrated in FIG. 14 and a sensor holder 302 as illustrated in FIG. 15 are attached to the lens holder 300. The sensor substrate 301 is a member to which the image sensor 31b is fixed. The sensor substrate 301 is fixed to the sensor holder 302.

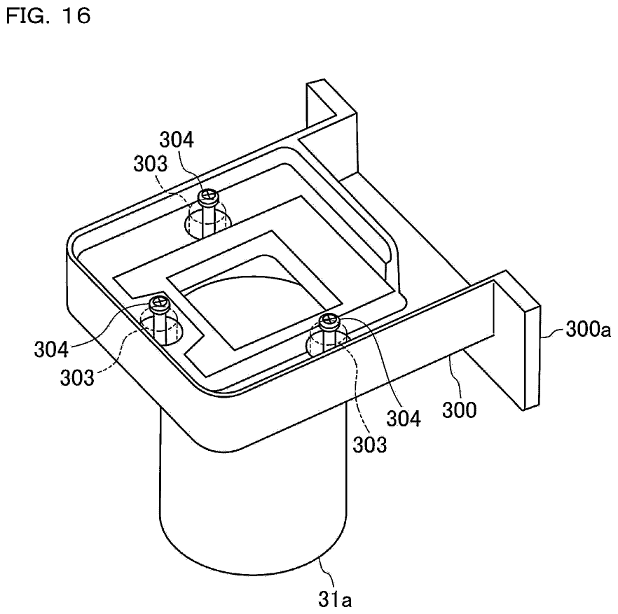

As illustrated in FIG. 16, in a state where the sensor holder 302 is removed, three springs 303 provided inside the lens holder 300 can be seen. Three springs (coil springs) 303 are disposed so as to surround an extended line of the optical axis of lens 31a. The plate-shaped sensor holder 302 is disposed so as to overlap the spring 303. An adjustment screw 304 is inserted into a portion of the sensor holder 302 corresponding to the spring 303. Each adjustment screw 304 is screwed into the lens holder 300 while being inserted into the spring 303. The angle of the sensor holder 302 can be changed by tightening or loosening each adjustment screw 304. Since the image sensor 31b is fixed to the sensor holder 302 via the sensor substrate 301, the relative angle between the image sensor 31b and the lens 31a, that is, the tilt can be adjusted by changing the angle of the sensor holder 302. After the adjustment, each member is bonded to the lens holder 300 with an adhesive so as not to move relative to each other.

When the first code reader 1A is installed as illustrated in FIGS. 1 and 2, the bottom surface of the workpiece W conveyed by the conveyance device B is exposed to the first code reader 1A side from the gap between the upstream conveyance mechanism B1 and the downstream conveyance mechanism B2. The depth of field of the imaging unit 3 of the first code reader 1A includes the bottom surface of the workpiece W exposed from the gap of the conveyance device B. As a result, the imaging unit 3 can directly capturing the bottom surface of the workpiece W through the gap between the upstream conveyance mechanism B1 and the downstream conveyance mechanism B2. The term “directly” means that the imaging unit 3 captures the bottom surface of the workpiece W without interposing a reflecting member such as a mirror.

In the case of being installed as illustrated in FIGS. 1 and 2, the light receiving window 622 and the gap of the conveyance device B are aligned. In this state, the row direction of the image sensor 31b corresponds to the direction in which the gap of the conveyance device B extends, and the column direction of the image sensor 31b corresponds to the conveyance direction of the conveyance device B (the direction indicated by the arrow A in FIG. 1).

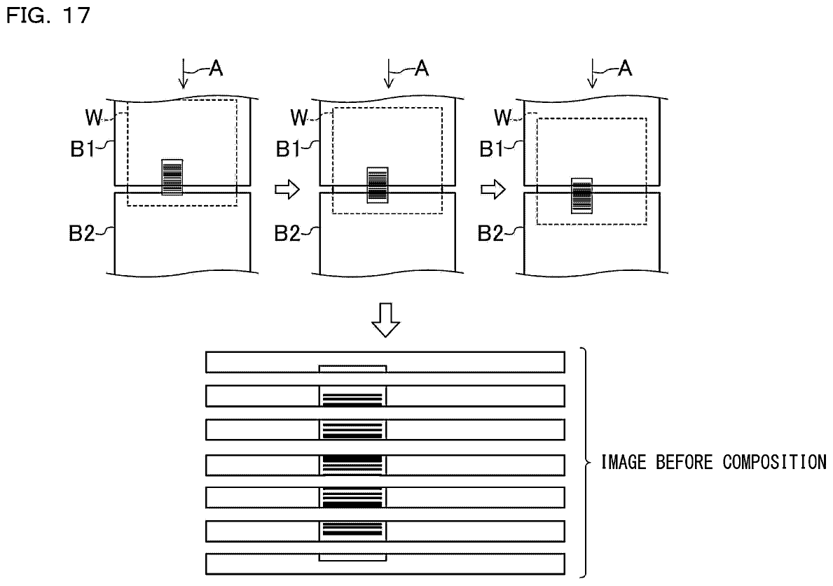

Therefore, as illustrated in FIG. 17, the imaging unit 3 outputs a plurality of images in which a part of the code attached to the bottom surface of the workpiece W is captured by continuously capturing the bottom surface of the workpiece W exposed from the gap of the conveyance device B and included in the depth of field of the imaging unit 3. The upper side of FIG. 17 illustrates a case where the upstream conveyance mechanism B1 and the downstream conveyance mechanism B2 that convey the workpiece W are viewed from below, and the workpiece W is conveyed as illustrated from the left to the right. Since the dimension of the code in the conveyance direction is longer than the gap between the upstream conveyance mechanism B1 and the downstream conveyance mechanism B2, only a part of the code in the conveyance direction is exposed downward from the gap between the upstream conveyance mechanism B1 and the downstream conveyance mechanism B2. As illustrated in the lower part of FIG. 17, a plurality of images in which a part of the code in the conveyance direction is captured are sequentially output from the imaging unit 3. The plurality of images output from the imaging unit 3 are input to the control unit 4.

The control unit 4 is a unit that generates a composite image on the basis of the plurality of images output from the imaging unit 3 and executes decoding processing on the code attached to the bottom surface of the workpiece W on the basis of the composite image. As illustrated in FIG. 2, as a specific configuration example of the control unit 4, for example, a configuration example including a microcomputer including a processor (including a central processing unit), a ROM, a RAM, and the like can be exemplified. The imaging control unit 41, the illumination control unit 42, the code detection unit 43, and the decoding unit (decoder) 44 are configured by hardware included in the control unit 4, software executed by the control unit 4, and the like.

The code detection unit 43 of the control unit 4 is a unit that specifies a code region on the basis of the code image output from the imaging unit 3 and detects a code from the specified code region. The decoding unit 44 of the control unit 4 is a unit that decodes the code detected by the code detection unit 43, and specifically, since the code is represented by the black-and-white binarized data, the decoding unit decodes the black-and-white binarized data. For decoding, a table indicating a contrast relationship of encoded data can be used. Further, the decoding unit 44 checks whether the decoding result is correct according to a predetermined check method. In a case where an error is found in the data, correct data is calculated using an error correction function. The error correction function varies depending on the type of code. Hereinafter, details of the code detection unit 43 and the decoding unit 44 of the first code reader 1A will be specifically described, but the same applies to the second to fourth code readers 1B, 1C, and 1D.

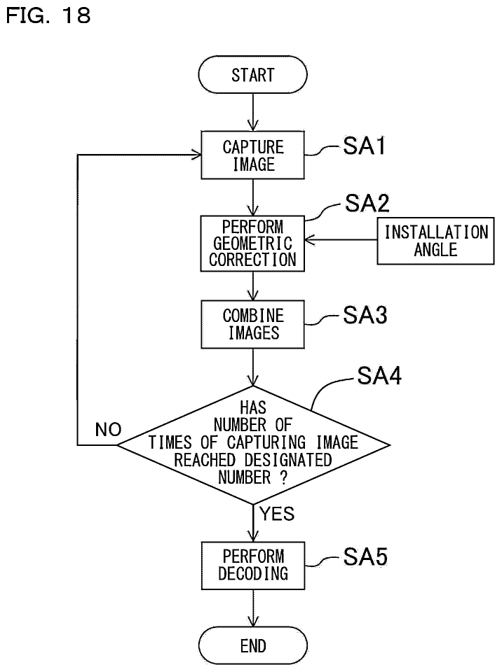

Hereinafter, details of processing by the control unit 4 will be described with reference to the flowchart illustrated in FIG. 18. This flowchart starts when the operation of the first code reader 1A for the bottom surface is started. In step SA1 after the start, the reading start trigger signal is input from the PLC 201 to the first code reader 1A. When the reading start trigger signal is input, the illumination control unit 42 turns on the illumination section 2, and the imaging control unit 41 causes the imaging unit 3 to capture an image to generate an image.

In step SA2, the code detection unit 43 executes geometric correction as necessary. For example, in a case where the first code reader 1A is installed on the side of the conveyance device B and in an installation state where a geometric change according to the installation angle of the first code reader 1A occurs, each image has a trapezoidal diameter. In this case, in step SA2, the trapezoid correction is executed on the trapezoid shape of each image. As a result, an image similar to that in the case of capturing from directly below the workpiece W can be obtained.

In step SA3, the code detection unit 43 combines the plurality of processed images subjected to the geometric correction in step SA2 to generate a combined image including the code. In step SA4, it is determined whether the number of times of capturing an image of the imaging unit 3 has reached a designated number. The number of times is set to the number of times the entire code can be imaged. In a case where it is determined as NO in step SA4, the process proceeds to step SA1, and capturing an image, geometric correction, and image synthesis are repeated until the entire code is captured. In a case where it is determined as YES in step SA4, the process proceeds to step SA5.

In step SA5, the code detection unit 43 generates a plurality of edge images by applying a plurality of edge extraction filters for extracting edges of different frequencies to the image combined in step SA3, and then executes integration processing of the plurality of edge images. The code detection unit 43 determines a code candidate position on the basis of the result of the edge integration processing. That is, in the edge-processed image, a region where many pixels having large luminance values gather can be estimated as the code region.

For example, in order to search for the position of the code in the code image, the code detection unit 43 can generate a heat map image indicating code likeness. That is, the code detection unit 43 quantifies the characteristic amount of the code, generates a heat map in which the magnitude of the characteristic amount is assigned to each pixel value, and extracts a code candidate region in which the code is likely to exist on the heat map. As a specific example, there is a method of acquiring a feature portion of a code in a region that is relatively hot (has a large characteristic amount) in a heat map. In a case where a plurality of feature portions is acquired, the feature portions can be preferentially extracted and stored in a RAM or the like. By using the heat map image, the code region can be detected at high speed. The decoding unit 44 decodes the code searched by the code detection unit 43.

As illustrated in FIGS. 3, 6, and 8, the first code reader 1A includes a communication interface 80 for transmitting information regarding a result of decoding processing by the decoding unit 44. The communication interface 80 is a portion to which the signal lines 200a and 201a and the like are connected, for example, and is provided at an end in the longitudinal direction of the housing 60. In this embodiment, the communication interface 80 is provided on the side where the imaging unit 3 is disposed, that is, the first end surface 65.

The connection direction of the signal lines 200a and 201a to the communication interface 80 is a direction along the longitudinal direction of the housing 60. As a result, the signal lines 200a and 201a do not protrude from the side surfaces 61 to 64 of the housing 60.

The first code reader 1A includes a bracket 810 as an attachment portion for attaching the housing 60 to the frame 830. The bracket 810 is provided on a side different from the light receiving window 622 of the housing 60, that is, on the third side surface 63. The side surface provided with the light receiving window 622 is the first side surface 61, and the first side surface 61 and the third side surface 63 are adjacent to each other. That is, among the first to fourth side surfaces 61 to 64 constituting the outer surface of the housing 60, the first side surface 61 (first side surface) including the light receiving window 622 and the irradiation surface 621 and the third side surface 63 (second side surface) on which the bracket 810 is provided are adjacent to each other.

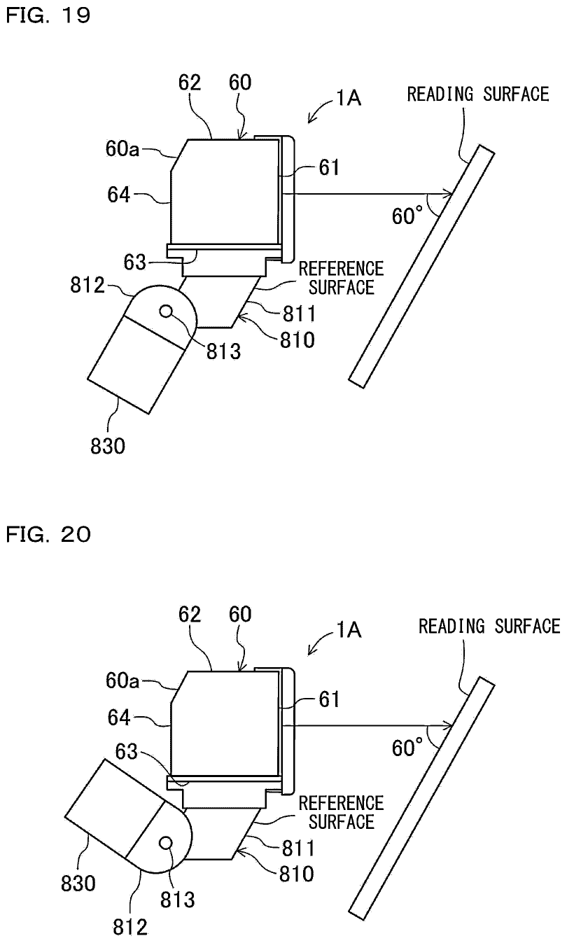

The bracket 810 includes a housing-side member 811 fixed to the housing 60, a frame-side member 812 fixed to the frame 830, and a connecting shaft 813 rotatably connecting the housing-side member 811 and the frame-side member 812. By rotating the housing-side member 811 with respect to the frame-side member 812, the installation angle of the housing 60 can be freely adjusted, and the angle illustrated in FIG. 19 can be changed to the angle illustrated in FIG. 20 or vice versa. The housing-side member 811 and the frame-side member 812 can be fixed by a fastening member or the like so as not to relatively turn.

A guide surface 60a serving as a guide at the time of installation is formed in the housing 60. The guide surface 60a is formed by chamfering a part of the housing 60. For example, in a case where the angle between the reading surface and the optical axis of the imaging unit 3 is 60°, the angle of the guide surface 60a is set such that the guide surface 60a and the reading surface have a parallel relationship. Furthermore, in a case where the angle between the reading surface and the optical axis of the imaging unit 3 is 60°, the surface (reference surface) of the housing-side member 811 on the reading surface side is formed to have a parallel relationship with the reading surface, and the distance between the reading surface and the reference surface may be regarded as the installation distance of the code reader 1A (particularly, the imaging unit 3).

Here, in order to respond to various needs and uses from the user, it is assumed that a plurality of types of code readers having different reading distances (that is, optical systems) are developed. When the bracket 810 (housing-side member 811) is attached to the code reader 1, as long as the reference surface of the bracket 810 and the imaging unit 3 of the code reader 1 are designed so as to have substantially the same positional relationship regardless of the type of the code reader 1, the user is only required to measure the installation distance on the basis of the reference surface of the common bracket 810 regardless of the type of the code reader 1. Therefore, the attachment by the user is simplified, and there is no need to provide an individual bracket 810 for each type of the code reader 1.

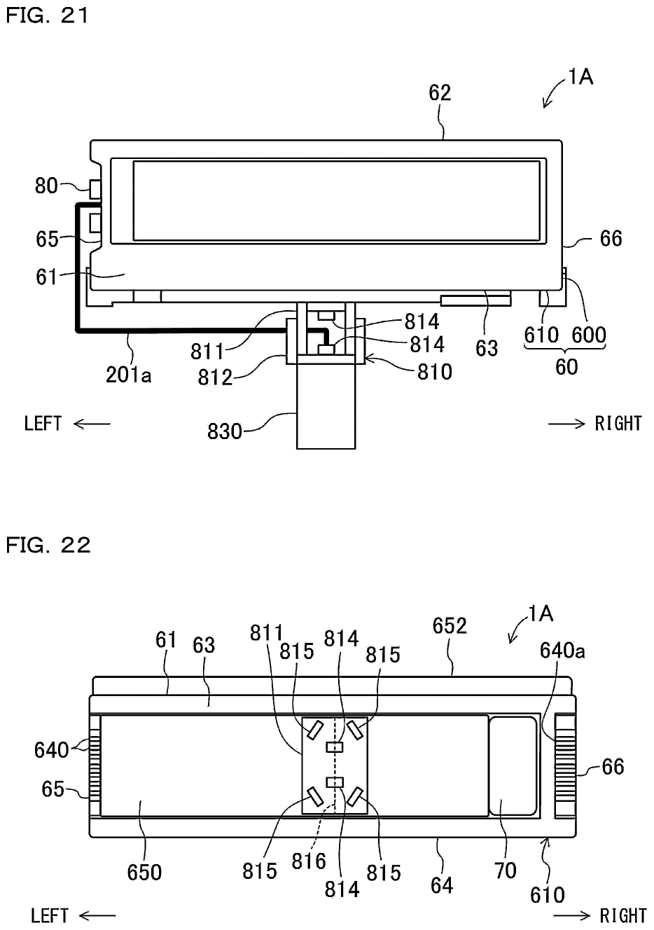

FIG. 21 illustrates a case where the housing 60 is viewed from the front. As illustrated in this drawing, the bracket 810 is provided with a pressing portion 814 for pressing the signal line 201a. By providing the pressing portion 814, the signal line 201a can be positioned at a predetermined position. The pressing portion 814 includes, for example, a convex portion or the like.

FIG. 22 is a bottom view of the housing-side member 811 fixed to the housing 60. The housing-side member 811 is formed with an attachment hole 815 for attachment to the housing 60, and by using the attachment hole 815, the housing-side member 811 can be fixed to the housing 60 using a screw (not shown). In addition, the housing-side member 811 is provided with a visual field center marker 816 for indicating the visual field center. The visual field center can be easily grasped by viewing the visual field center marker 816 at the time of installation and aligning the visual field center marker with the frame-side member 812.

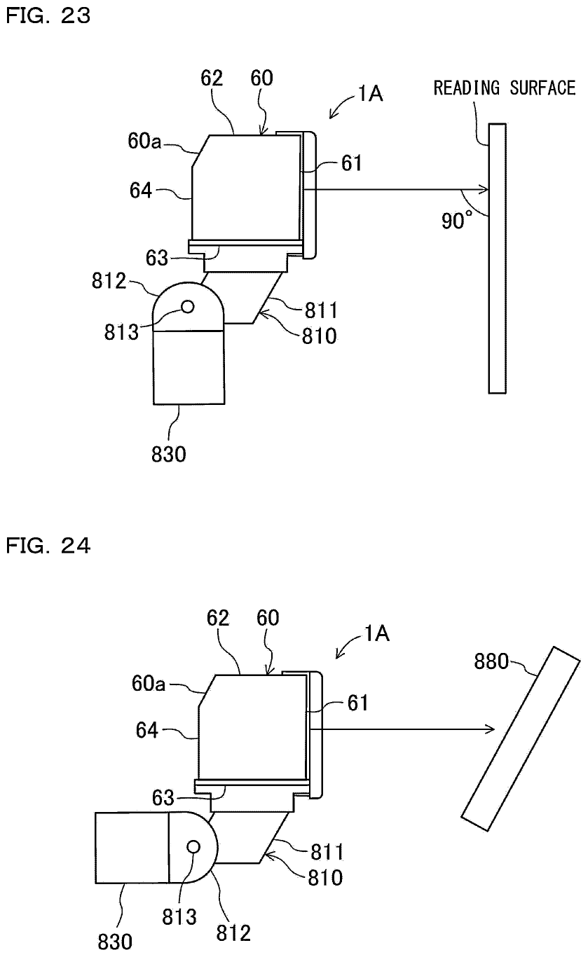

FIG. 23 is a side view illustrating an attachment example in which the optical axis of the imaging unit 3 is orthogonal to the reference surface. As illustrated in this drawing, the installation angle of the housing 60 can be adjusted to make the optical axis of the imaging unit 3 orthogonal to the reference surface. FIG. 24 illustrates an attachment example in a case where a mirror is used, and the housing 60 can also be installed such that a mirror 880 is interposed between the imaging unit 3 and the workpiece W. When the mirror 880 is interposed, reflected light from the code is reflected by the mirror 880 and enters the imaging unit 3. In addition, the illumination light emitted from the illumination section 2 is reflected by the mirror 880 and reaches the workpiece W to which the code is attached. Interposing the mirror 880 improves the degree of freedom in installation of the housing 60.

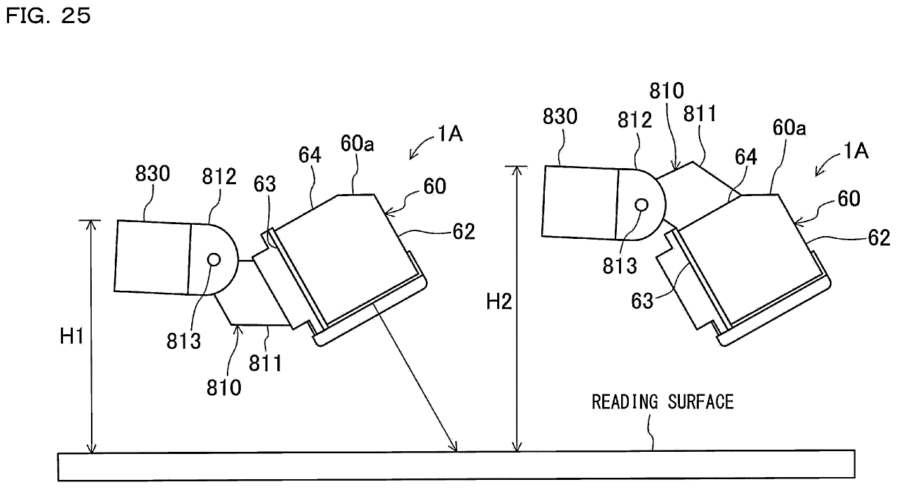

FIG. 25 illustrates an installation example in a case where the attachment surface of the bracket 810 is changed. The left side of FIG. 25 illustrates a case where the bracket 810 is attached to the third side surface 63 of the housing 60, and the right side of FIG. 25 illustrates a case where the bracket 810 is attached to the fourth side surface 64 of the housing 60. As illustrated in FIG. 25, by attaching the bracket 810 to the third side surface 63 of the housing 60, the height of the frame 830 from the reference surface becomes a first height H1, and can be made lower than the case of being attached to the fourth side surface 64 (second height H2). Therefore, for example, by applying the present attachment structure to the code readers 1A to 1D illustrated in FIGS. 1 and 2, the protrusion amounts of the code readers 1A to 1D from each of the members 831 to 833 of the frame 830 to the conveyance device B side are reduced, so that the degree of freedom in installation can be improved.

### OTHER EMBODIMENTS

The embodiment of the invention is not limited to the above embodiment, and may be, for example, other embodiments as described below. In the following description of another embodiment, the same members as those in the above embodiment will be denoted by the same reference numerals, description thereof will be omitted, and different portions will be described in detail. In addition, by combining the above embodiment and the following other embodiments, it is also possible to make still other embodiments. When combining the above embodiment with the following other embodiments, the position of the above embodiment and a part of the following other embodiments can be combined.

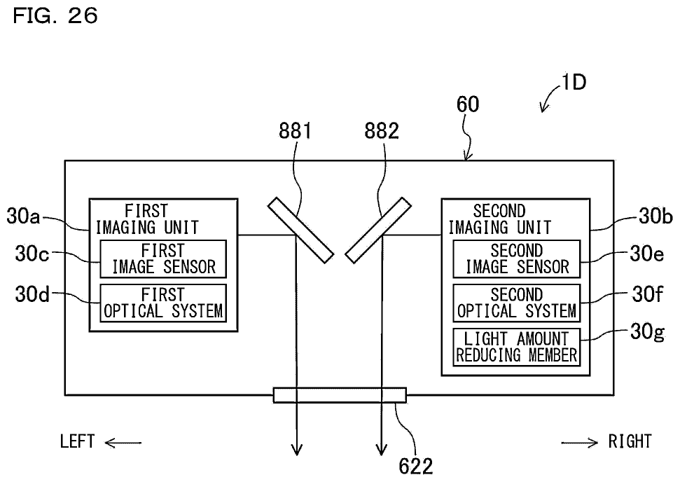

The first example illustrated in FIG. 26 is an example in which an imaging unit 30 of the fourth code reader 1D includes a first imaging unit 30a and a second imaging unit 30b. The first to third code readers 1A, 1B, and 1C can be similarly configured. The first imaging unit 30a and the second imaging unit 30b are stored in a state of being divided into left and right. The first imaging unit 30a is stored on the left side of the housing 60, and the second imaging unit 30b is stored on the right side of the housing 60. A first mirror 881 and a second mirror 882 are stored in the center of the housing 60 in the left-right direction. The first mirror 881 is a member for allowing reflected light from the code to enter the first imaging unit 30a. The second mirror 882 is a member for allowing reflected light from the code to enter the second imaging unit 30b.

The first imaging unit 30a includes a first image sensor 30c and a first optical system 30d. The first image sensor 30c has a two-dimensional light receiving surface for forming a predetermined visual field, and is a member that generates an image corresponding to an image projected on the light receiving surface via a light receiving window 622. The first optical system 30d is a member that is interposed between the light receiving window 622 and the light receiving surface of the first image sensor 30c and projects an image corresponding to the code attached to the workpiece W in the housing 60 onto the light receiving surface of the first image sensor 30c. The first optical system 30d is long along the longitudinal direction of the light receiving window 622, and forms an optical path in which an optical axis passing through the center of the visual field is inclined with respect to the longitudinal direction. The visual field and the depth of the first imaging unit 30a can be set by various parameters of the first optical system 30d.

The second imaging unit 30b includes a second image sensor 30e and a second optical system 30f. The second image sensor 30e has a two-dimensional light receiving surface for forming a predetermined visual field, and is a member that generates an image corresponding to an image projected on the light receiving surface via a light receiving window 622. The second optical system 30f is a member that is interposed between the light receiving window 622 and the light receiving surface of the second image sensor 30e and projects an image corresponding to the code attached to the workpiece W in the housing 60 onto the light receiving surface of the second image sensor 30e. The second optical system 30f is long along the longitudinal direction of the light receiving window 622, and forms an optical path in which an optical axis passing through the center of the visual field is inclined with respect to the longitudinal direction. The visual field and the depth of the second imaging unit 30b can be set by various parameters of the second optical system 30f. The optical axis of the first imaging unit 30a and the optical axis of the second imaging unit 30b have a close relationship.

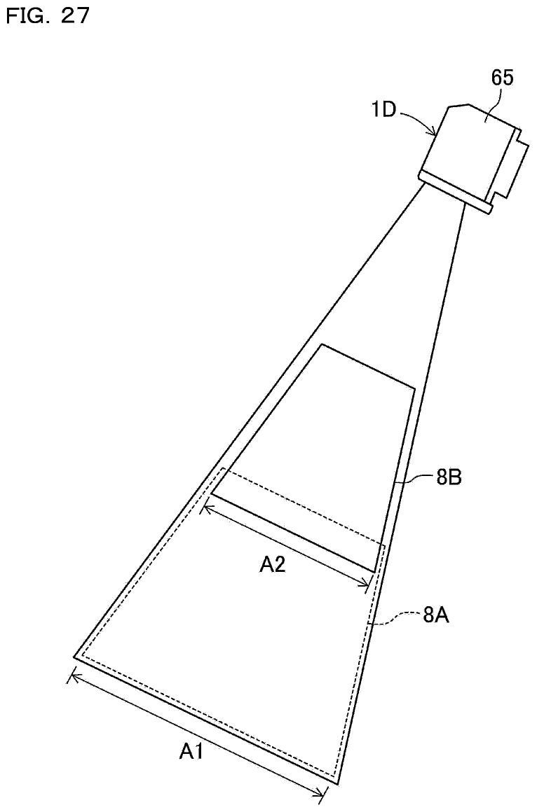

The visual field and the depth of the first imaging unit 30a are different from the visual field and the depth of the second imaging unit 30b. Specifically, the visual field and the depth of the first imaging unit 30a are a range (referred to as a first range) surrounded by a broken-line frame indicated by reference numeral 8A in FIG. 27. Various parameters of the first optical system 30d are set so as to be in the first range 8A. On the other hand, the visual field and the depth of the second imaging unit 30b are in a range (referred to as a second range) surrounded by a solid frame indicated by reference numeral 8B in FIG. 27. Various parameters of the second optical system 30f are set so as to be in the second range 8B.

The first range 8A is set to include a region farther than the second range 8B, and the farthest visual field range A1 of the first range 8A is extended from the farthest visual field range A2 of the second range 8B. The second range 8B is set to include a region closer than the first range 8A. By providing the first image sensor 30c and the second image sensor 30e, the visual field and the depth of the imaging unit 30 are expanded. In short, the imaging unit 30 includes a first image sensor 30c and a second image sensor 30e for expanding the visual field and the depth in the depth direction orthogonal to the plane forming the light receiving window 622 in the imaging visual field. Note that a third imaging unit may be provided in addition to the first imaging unit 30a and the second imaging unit 30b. In this case, the visual fields and the depths of the first imaging unit 30a, the second imaging unit 30b, and the third imaging unit can be configured to be different from each other.

Since the first imaging unit 30a is an imaging unit capable of capturing a farther side than the second imaging unit 30b, it can also be referred to as a far imaging unit. On the other hand, since the second imaging unit 30b is an imaging unit capable of capturing the near side of the first imaging unit 30a, it can also be referred to as a near imaging unit. As described above, the imaging unit 30 includes a near imaging unit that captures the near side and a far imaging unit that captures the far side. In a case where the third imaging unit is provided, the third imaging unit can be, for example, a short-range imaging unit.

The first code reader 1A further includes a light amount reducing member 30g (shown in FIG. 26) that reduces the light amount difference from the light amount incident on the first image sensor 30c of the first imaging unit 30a that is the far imaging unit by reducing the light amount incident on the second image sensor 30e of the second imaging unit 30b that is the near imaging unit. As a result, since the luminance difference between the images obtained by the imaging units is suppressed, parameter switching due to the difference in luminance value is unnecessary in the image processing in the subsequent stage, and the processing load can be reduced. The light amount reducing member 30g includes a light reducing filter (for example, an ND filter) provided in the second optical system 30f of the second imaging unit 30b. The light reduction amount by the light reducing filter can be arbitrarily set. The light amount reducing member 30g may be provided as necessary, and may be omitted.

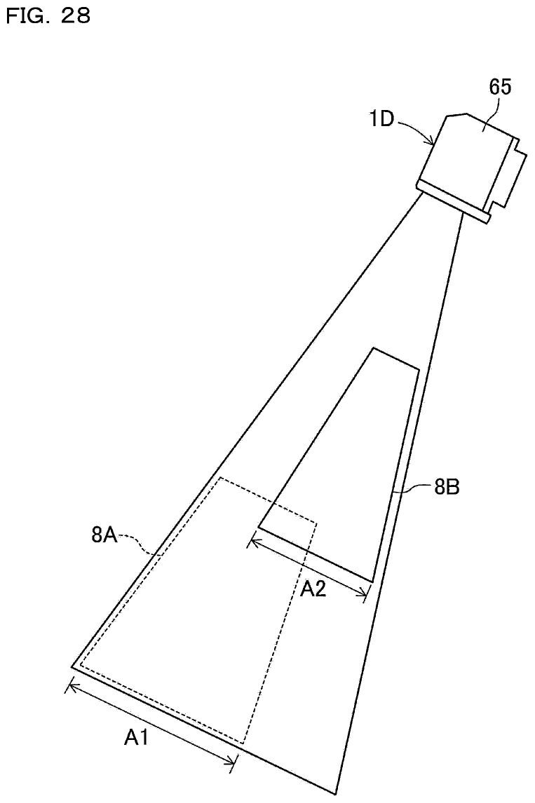

FIG. 28 illustrates a second example, which is the same as the first example in that the imaging unit 30 includes a first imaging unit 30a and a second imaging unit 30b, but is different from the first example in the visual field and the depth of the first image sensor 30c and the second image sensor 30c. In addition, the optical axis of the first imaging unit 30a and the optical axis of the second imaging unit 30b are separated from each other as compared with the first example. That is, in the second example, the first range 8A is set to be located below the second range 8B and to include a region farther than the second range 8B. The visual field and the depth of the imaging unit 30 are extended by the farthest visual field range A1 of the first range 8A and the farthest visual field range A2 of the second range 8B. In the second example, since the optical path of the first imaging unit 30a and the optical path of the second imaging unit 30b do not match, a partial region of the light receiving window 622 is a portion corresponding to the optical path of the first imaging unit 30a, and the other region is a portion corresponding to the optical path of the second imaging unit 30b. In this case, the light amount reducing member 30g can include a light reducing filter provided in a portion of the light receiving window 622 corresponding to the optical path of the second imaging unit 30b. As a result, it is possible to reduce the light amount difference between the light amount incident on the second image sensor 30c of the second imaging unit 30b and the light amount incident on the first image sensor 30c of the first imaging unit 30a. Also in the second example, similarly to the first example, a light reducing filter may be provided in the second optical system 30f.

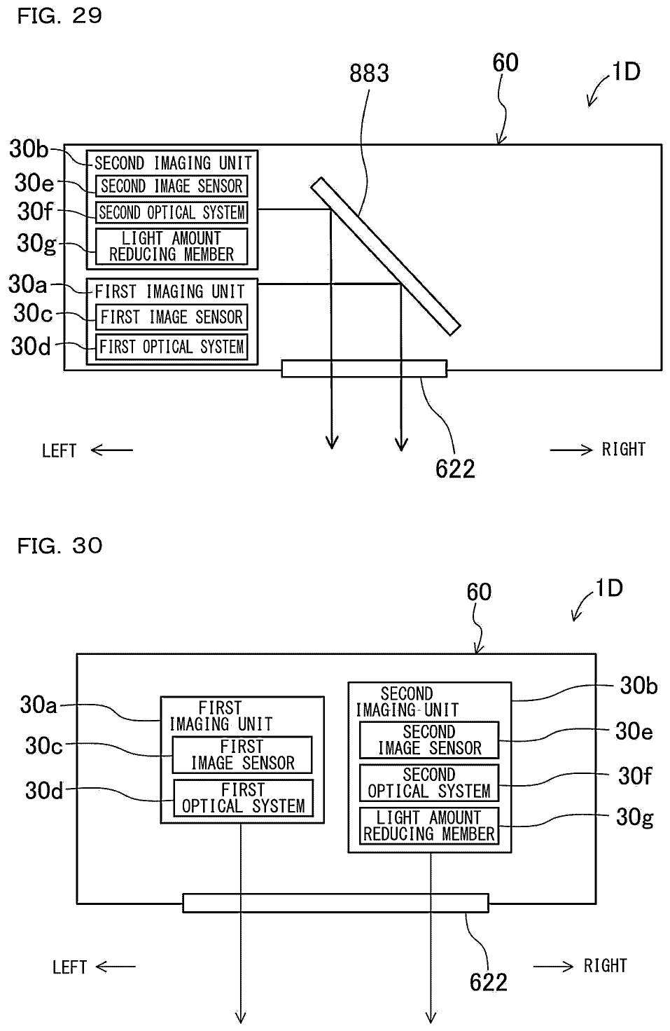

FIG. 29 is a view illustrating a third example in which the first imaging unit 30a and the second imaging unit 30b are stored on the left side of the housing 60. In the third example, a mirror 883 is stored in the center of the housing 60 in the left-right direction. The mirror 883 is a member for allowing reflected light from the code to enter the first imaging unit 30a and the second imaging unit 30b. Also in this example, by providing the first imaging unit 30a and the second imaging unit 30b, the visual field and the depth can be expanded as described above. Note that the first imaging unit 30a and the second imaging unit 30b may be stored on the right side of the housing 60.

FIG. 30 is a view illustrating a fourth example in which the first imaging unit 30a and the second imaging unit 30b are stored in the central portion of the housing 60 in the left-right direction. In the fourth example, the reflected light from the code passes through the light receiving window 622 and then enters the first imaging unit 30a and the second imaging unit 30b.

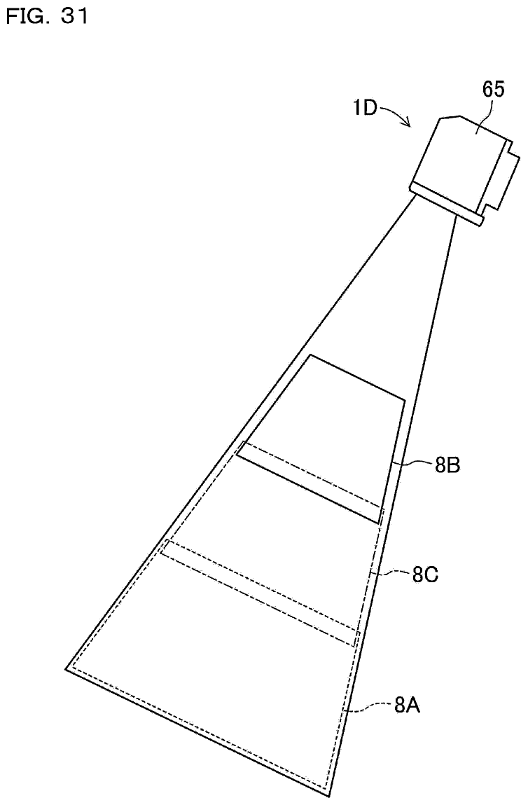

FIG. 31 is a view illustrating a case where a variable focus lens capable of focus adjustment is used as the lens 31a of the imaging unit 3. By using the variable focus lens, the depth of the imaging unit 3 can be changed in a plurality of stages. In this example, the depth of the imaging unit 3 is changed in three stages of a first range 8A focused on a far side, a second range 8B focused on a near side, and a third range 8C focused at a middle distance. As a result, the visual field and the depth can be expanded without increasing the number of imaging units 3. Note that the depth of the imaging unit 3 may be changed in two stages, or may be changed in four or more stages. The variable focus lens includes, for example, a mechanically movable lens and a liquid lens.

The plurality of other embodiments described above may be independent from each other, but any plurality of other embodiments among the plurality of other embodiments may be combined with each other.

The invention is not limited to the code reader. For example, a part of the invention can also be applied to a case where a control unit configured not to execute code decoding processing is provided. In this case, the image processing device is an image processing device that processes an image acquired by capturing an image of the workpiece W conveyed by the conveyance device B, and the control unit is a part that executes various types of image processing. Examples of the various types of image processing include OCR processing and image inspection processing.

The above-described embodiments are merely examples in all respects, and should not be construed in a limiting manner. Further, all modifications and changes falling within the equivalent scope of the claims are within the scope of the invention.

As described above, the code reader according to the disclosure can be used, for example, in the case of reading a code attached to a workpiece.

What is claimed is:

1. A stationary code reader that is configured to be usable in a state of being attached to an external frame and that reads a code attached to a workpiece conveyed by a conveyance device, the code reader comprising:
a housing that is long along a first direction and has a light receiving window that transmits light laterally intersecting the first direction;
an illumination section that is stored in the housing and forms an irradiation surface arranged side by side with the light receiving window along the first direction, the irradiation surface for irradiating a workpiece with illumination light;
an imaging unit including an image sensor and a lens, the image sensor having a two-dimensional light receiving surface and being installed in the housing toward the first direction, the lens projecting an image corresponding to a code attached to a workpiece on a light receiving surface of the image sensor in the housing;
a mirror that turns back an optical path corresponding to a visual field of the imaging unit in a direction of the light receiving window in the housing;
a decoder that executes decoding processing of the code attached to the workpiece based on the image generated by the imaging unit; and
an attachment portion that is provided on a side of the housing different from a side of the light receiving window and configured to attach the housing to the external frame.

2. The code reader according to claim 1, further comprising
a communication interface that is provided at an end in the first direction of the housing and configured to transmit information regarding a result of decoding processing by the decoder.

3. The code reader according to claim 1, wherein a first side surface including the light receiving window and the irradiation surface and a second side surface on which the attachment portion is provided are adjacent to each other, among a plurality of side surfaces constituting an outer surface of the housing.

4. The code reader according to claim 1, wherein
the light receiving surface is inclined with respect to an optical axis of the lens, and
the lens and the image sensor constitute a Scheimpflug optical system.

5. The code reader according to claim 1, wherein the imaging unit includes the lens or a plurality of the image sensors, for expanding a visual field or a depth in a depth direction orthogonal to a plane forming the light receiving window in the visual field.

6. The code reader according to claim 1, wherein
the imaging unit includes a near imaging unit that captures a near side and a far imaging unit that captures a far side, and
the code reader further comprises a light amount reducing member configured to reduce a light amount difference from a light amount incident on the image sensor of the far imaging unit by reducing a light amount incident on the image sensor of the near imaging unit.

7. The code reader according to claim 6, wherein the light amount reducing member includes a light reducing filter provided in an optical system of the near imaging unit.

8. The code reader according to claim 6, wherein the light amount reducing member includes a light reducing filter provided in a portion corresponding to an optical path of the near imaging unit in the light receiving window.

9. The code reader according to claim 1, wherein the illumination section includes a first illumination section and a second illumination section that are disposed apart from each other in the first direction.

10. The code reader according to claim 9, wherein the mirror is disposed between the first illumination section and the second illumination section.

11. The code reader according to claim 10, wherein the imaging unit is disposed on a back side of the first illumination section or a back side of the second illumination section in the housing.

12. The code reader according to claim 1, wherein the illumination section includes a first irradiation angle illumination section in which spread of irradiation light has a first irradiation angle, and a second irradiation angle illumination section in which spread of irradiation light has a second irradiation angle wider than the first irradiation angle, and the first irradiation angle illumination section and the second irradiation angle illumination section are arranged in the first direction.

13. The code reader according to claim 1, wherein a light projecting window, which is configured to transmit illumination light emitted from the illumination section to an outside of the housing, and the light receiving window are formed of a common light transmitting member.

14. The code reader according to claim 13, wherein
the light transmitting member is formed to be long in the first direction, and
the code reader further comprises:
a window frame member for fixing the light transmitting member to the housing; and
a packing interposed between the window frame member and the light transmitting member.

15. The code reader according to claim 1, wherein a light shielding member that prevents the illumination light emitted from the illumination section from entering the lens of the imaging unit is provided inside the housing.

16. The code reader according to claim 1, wherein
at least a part of the housing is formed of a first housing constituent member made of metal and having a heat dissipation fin extending in a predetermined direction, and
a control board provided with the decoder is attached to the first housing constituent member via a member having heat transfer property.

17. The code reader according to claim 16, wherein
the heat dissipation fin extends along the first direction, and
the code reader further comprises a fan that blows air in a longitudinal direction of the heat dissipation fin.

18. The code reader according to claim 16, wherein
a part of the housing is formed of the first housing constituent member,
another part of the housing is formed of a second housing constituent member made of resin, and
the first housing constituent member and the second housing constituent member are integrated.

19. The code reader according to claim 1, wherein
the housing includes
a light receiving room that stores the imaging unit and the mirror and is isolated from the illumination section, and an indicator that forms a part of the light receiving room and emits light based on a processing result of the decoder,
the code reader further comprises a control unit that controls the imaging unit, the decoder, and the indicator, and
the control unit executes turning-off control to turn off the indicator at least during exposure by the imaging unit.

20. A stationary image processing device that is configured to be usable in a state of being attached to an external frame and that processes an image acquired by capturing an image of a workpiece conveyed by a conveyance device, the image processing device comprising:
a housing that is long along a first direction and has a light receiving window that transmits light laterally intersecting the first direction;
an illumination section that is stored in the housing and forms an irradiation surface arranged side by side with the light receiving window along the first direction, the irradiation surface for irradiating a workpiece with illumination light;
an imaging unit including an image sensor and a lens, the image sensor having a two-dimensional light receiving surface and being installed in the housing toward the first direction, the lens projecting an image corresponding to a workpiece on a light receiving surface of the image sensor in the housing;
a mirror that turns back an optical path corresponding to a visual field of the imaging unit in a direction of the light receiving window in the housing;
a control unit that executes image processing based on an image generated by the imaging unit; and
an attachment portion that is provided on a side of the housing and configured to attach the housing to the external frame.
